(19) United States
(12) Patent Application Publication
(10) Pub. No.: US 2026/0291890 A1
(43) Pub. Date: Sep. 24, 2026

(54) SYSTEM

(71) Applicant: SoftBank Group Corp., Tokyo (JP)

(72) Inventor: Toshiaki INABA, Tokyo (JP)

(73) Assignee: SoftBank Group Corp., Tokyo (JP)

(21) Appl. No.: 19/567,322

(22) Filed: Mar. 16, 2026

(30) Foreign Application Priority Data
Mar. 19, 2025 (JP) 2025-045274

(51) Int. Cl. H04L 51/02; G06N 3/045; G10L 15/22

(52) U.S. Cl. CPC H04L 51/02; G06N 3/045; G10L 15/22; G10L 2015/225

(57) ABSTRACT

A system includes a processor that is configured to analyze an article obtained from an information source and extract important keywords and themes from the article, generate a prompt sentence by using a generative AI model based on the extracted keywords and themes, convert a user's utterance from speech to text and analyze the text by using natural language processing techniques, and evaluate, based on a result of the analysis, a quality of language used in a discussion, an accuracy of sentences, and a logical content, and generate feedback.

### CROSS-REFERENCE TO RELATED APPLICATION

This application is based on and claims priority under 35 USC 119 from Japanese Patent Application No. 2025-045274 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional language-learning and discussion-support systems often fail to provide integrated, real-time, and context-aware feedback that is directly tied to current articles or topics. In existing systems, the process from topic selection, prompt generation, user utterance analysis, and feedback provision is frequently fragmented. Articles may be presented to users, but prompts for discussion are typically static and manually prepared, making it difficult to adapt to specific keywords or themes in the articles. Furthermore, although some systems can convert speech to text or perform basic grammatical checks, they do not sufficiently evaluate the overall language quality, sentence accuracy, and logical content of user utterances in a coherent manner. As a result, users cannot easily obtain personalized, actionable feedback that helps them improve their discussion skills in a continuous learning cycle. Therefore, there is a need for a system that automatically analyzes articles from information sources, generates suitable prompts based on extracted keywords and themes, converts and analyzes user utterances, evaluates multiple qualitative aspects of the utterances, and produces feedback that is also used to refine future prompt generation.

### SUMMARY

In order to solve the above problems, an aspect of the present invention provides a system comprising a processor. The processor is configured to analyze an article obtained from an information source and to extract important keywords and themes from the article. The processor is further configured to generate a prompt sentence by using a generative AI model based on the extracted keywords and themes. The processor is also configured to convert a user's utterance from speech to text and to analyze the text by using natural language processing techniques. In addition, the processor is configured to evaluate, based on a result of the analysis, a quality of language used in a discussion, an accuracy of sentences, and a logical content, and to generate feedback. In some embodiments, the processor is configured to provide the generated feedback to the user and to reflect the feedback in prompt generation for a next discussion, thereby enabling a continuous improvement loop. In other embodiments, the processor is configured to customize the prompt sentence by using the generative AI model so as to instruct the user to make an utterance on a specific theme, thus tailoring the discussion to the user's learning needs and the characteristics of the analyzed article.

The term “system” refers to a combination of hardware and software components that cooperatively execute processing operations as described in the claims.

The term “processor” refers to one or more hardware processing units, such as a central processing unit (CPU), a graphics processing unit (GPU), a digital signal processor (DSP), or a combination thereof, capable of executing instructions to perform the claimed functions.

The term “information source” refers to any data provider or repository, including but not limited to websites, news feeds, databases, content servers, or local storage, from which an article can be obtained.

The term “article” refers to a body of text, such as a news article, blog post, report, or other written content, obtained from the information source and used as a basis for analysis and prompt generation.

The term “keyword” refers to a word or phrase identified from an article as being important or representative for understanding the main content, topic, or theme of the article.

The term “theme” refers to a central topic, subject matter, or main idea extracted from an article that characterizes what the article is about.

The term “generative AI model” refers to a machine learning model, such as a large language model or other generative model, that is capable of producing text, including prompt sentences, based on input data such as keywords and themes.

The term “prompt sentence” refers to a text generated by the generative AI model that is intended to guide, instruct, or encourage a user to speak or write about a particular topic or theme.

The term “user” refers to a person who interacts with the system, provides utterances, receives prompts and feedback, and participates in discussions supported by the system.

The term “utterance” refers to a segment of speech or spoken content produced by the user, which is converted into text and analyzed by the system.

The term “speech to text” refers to a process or function for automatically converting audio data representing a user's spoken utterance into corresponding textual data.

The term “natural language processing techniques” refers to computational methods and algorithms for analyzing text, including but not limited to tokenization, part-of-speech tagging, syntactic parsing, semantic analysis, or discourse analysis.

The term “analysis result” refers to data or output obtained by applying natural language processing techniques to the text of the user's utterance, including identified linguistic features, errors, structures, or semantic information.

The term “quality of language” refers to one or more measures of the linguistic appropriateness of an utterance, such as grammatical correctness, vocabulary richness, fluency, and naturalness.

The term “accuracy of sentences” refers to the degree to which sentences in an utterance are grammatically correct and structurally well-formed according to rules of the target language.

The term “logical content” refers to the structure and coherence of reasoning expressed in an utterance, including clarity of claims, consistency of arguments, and appropriateness of supporting reasons or conclusions.

The term “feedback” refers to information generated by the system and provided to the user that evaluates or comments on the user's utterance, including indications of strengths, weaknesses, errors, suggested corrections, and recommendations for improvement.

The term “next discussion” refers to a subsequent discussion session or conversational interaction, occurring after a current discussion, in which the user participates and for which prompt generation can be adjusted based on previous feedback.

The term “customize” refers to modifying or adapting characteristics of the prompt sentence, such as its content, style, or level of difficulty, based on user-related information, article characteristics, or past performance.

The term “specific theme” refers to a particular, identified subject or topic, derived from the analyzed article or designated by the system, on which the user is instructed to make an utterance.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

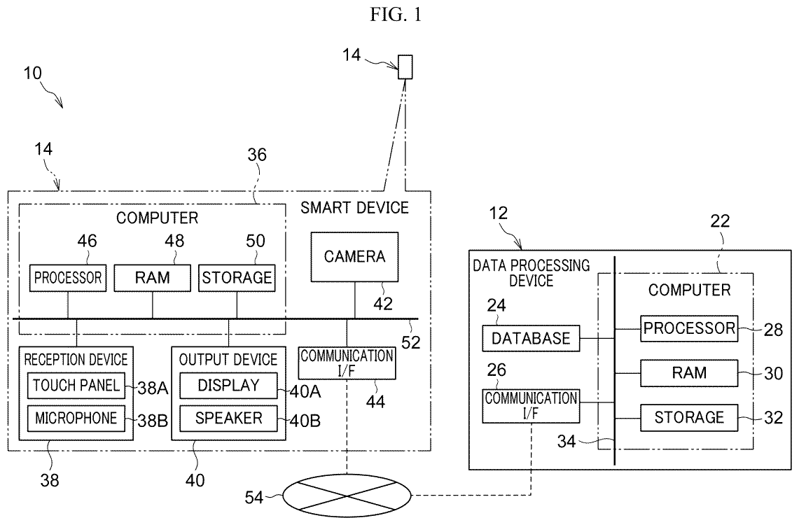

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

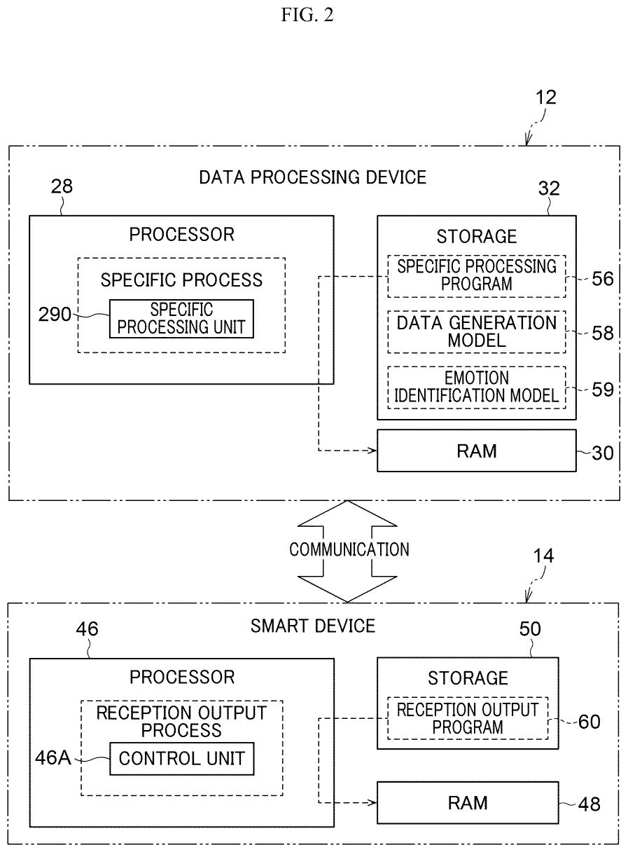

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented language training systems typically present static learning materials or pre-authored exercises and evaluate user responses with fixed rule-based scoring engines. Such systems are limited in their ability to dynamically adapt to a user's linguistic proficiency and reasoning ability, and they often fail to provide context-aware feedback in real time. As a result, these systems underutilize available computational resources and modern machine learning techniques, and they do not fully exploit rich content streams, such as continuously updated articles from networked information sources, for interactive debate-based training.

Further, existing architectures often separate content retrieval, prompt generation, speech recognition, natural language analysis, and feedback presentation into loosely integrated modules. This separation can cause inefficiencies such as duplicated processing, latency due to repeated network calls, and inconsistent treatment of context (for example, loss of linkage between an article, the derived debate theme, and the user's utterances). Consequently, the overall computer system may exhibit suboptimal performance, with increased processing overhead and degraded responsiveness in interactive debate sessions.

Moreover, many systems rely on fixed prompts or manually-authored questions, which are not automatically tuned to the user's historical performance or current learning needs. These systems do not leverage generative AI models to systematically and programmatically adjust prompt sentences in terms of length, difficulty, and depth of discussion points based on prior evaluation results. This leads to a mismatch between the computationally generated content and the user's evolving proficiency, resulting in inefficient use of processing cycles and network resources, since the same types of prompts may be repeatedly generated regardless of whether they are effective for a given user.

In addition, feedback generation is often limited to basic correctness checks and does not integrate advanced natural language processing for joint evaluation of grammar, vocabulary, and logical consistency in the context of a particular debate theme. Without a unified processing pipeline that captures user utterances via speech recognition, analyzes them in context using a generative AI model, and then structurally reuses the evaluation results to drive subsequent prompt generation, the computer system cannot provide an optimized interactive loop. This lack of integration reduces the technical effectiveness of the computing system for real-time debate management and adaptive language training.

Therefore, there is a need for a computer-implemented system that improves the functioning of the underlying computer by tightly integrating: (i) acquisition and summarization of text information from information sources; (ii) generation of debate-theme information; (iii) generation and adjustment of prompt sentences using a generative AI model; (iv) speech-to-text conversion of user utterances; (v) context-aware natural language analysis and evaluation; and (vi) feedback presentation via a terminal device. Such integration should reduce redundant processing, maintain consistent context across components, and adapt subsequent system behavior based on stored feedback and user history, thereby improving the overall technical performance, responsiveness, and effectiveness of the computer system in managing AI-supported debate sessions.

The specific processing by the specific processing unit 290 of the data processing device 12 in Example 1 is realized by the following means.

The present invention provides a server comprising a processor configured to analyze text information acquired from an information source to generate summary information and debate-theme information, to use a generative AI model to generate, based on the debate-theme information, a prompt sentence for starting a debate by a user and a prompt sentence for managing a progression of the debate, to acquire audio information uttered by the user via a terminal device and convert the audio information into character information by speech recognition processing, to use the generative AI model to analyze the character information and the debate-theme information by natural language processing and evaluate a language quality, textual correctness, and logical consistency of a content of the user's utterance, to generate feedback information including favorable points and improvement points of the content of the user's utterance based on the evaluation and present the feedback information to the user via the terminal device, and to adjust at least one subsequent prompt sentence for a next debate based on the feedback information and a speech history of the user. This enables an integrated computer-implemented processing pipeline that reduces redundant operations across content retrieval, prompt generation, speech recognition, and evaluation, maintains coherent contextual information throughout debate sessions, dynamically adapts computational behavior to user proficiency and historical performance, and thereby improves the technical performance, responsiveness, and effectiveness of the underlying computer system in executing interactive debate-based language training.

The term “information source” refers to any data-providing medium or platform, including a network-accessible service or storage system, from which text information such as articles, reports, or other textual content is acquired by the server.

The term “text information” refers to digital data representing human-readable textual content, including but not limited to articles, summaries, transcripts, and user utterances converted into character-based form.

The term “summary information” refers to text information generated by processing original text information to produce a condensed representation that preserves main points or key ideas while omitting less important details.

The term “debate-theme information” refers to text information that indicates a topic, issue, or subject for discussion, derived from or associated with underlying text information, and used to guide a debate session.

The term “generative AI model” refers to a machine-learned computational model configured to generate text or other content in response to an input prompt, the model being trained using data-driven methods such as neural network training.

The term “prompt sentence” refers to a text sequence supplied as input to a generative AI model or presented to a user, which specifies instructions, questions, or contextual information to elicit a generated response or a user utterance.

The term “audio information” refers to digital data representing acoustic signals, including speech produced by a user, which may be captured via a microphone or other audio input device.

The term “character information” refers to digital data representing textual content encoded as characters, such as letters, symbols, or punctuation, suitable for processing by natural language processing components.

The term “speech recognition processing” refers to computational operations that convert audio information representing spoken language into corresponding character information using an automatic speech recognition technique or engine.

The term “natural language processing” refers to computational techniques for analyzing, understanding, or generating human language in text form, including tasks such as parsing, semantic analysis, and discourse analysis.

The term “language quality” refers to characteristics of a user's utterance relating to grammar, syntax, vocabulary usage, and fluency, evaluated to determine how accurately and appropriately the language is used.

The term “textual correctness” refers to the degree to which a user's utterance conforms to normative language rules, including grammar, spelling, and word choice, when represented as character information.

The term “logical consistency” refers to the coherence and internal rationality of the content of a user's utterance, including whether claims, reasons, and conclusions are aligned and non-contradictory in the context of a debate theme.

The term “feedback information” refers to text information generated based on an evaluation of a user's utterance, including indications of favorable aspects, errors, and suggested improvements, which is intended to guide the user's future performance.

The term “favorable points” refers to portions or aspects of a user's utterance that are assessed as correct, effective, or desirable in terms of language quality or logical content.

The term “improvement points” refers to portions or aspects of a user's utterance that are assessed as needing correction, refinement, or enhancement in terms of language quality or logical content.

The term “terminal device” refers to any user-operated computing device, including but not limited to a mobile device, tablet, or personal computer, configured to communicate with the server and to input and output information to and from the user.

The term “speech history” refers to stored information representing past utterances or interactions of a user, including transcribed character information and associated evaluation results, used to adjust subsequent system behavior.

The term “visual display information” refers to feedback information or related data that is presented to a user in a graphical or textual form on a display unit of a terminal device.

The term “audio output information” refers to feedback information or related data that is presented to a user in audible form, generated by converting text to speech or playing pre-recorded audio via an output device.

The term “user interface” refers to a collection of input and output mechanisms on a terminal device, including graphical elements, controls, and audio components, through which the user interacts with the system.

The term “re-utterance” refers to a subsequent spoken statement by the user, produced after receiving feedback information, which may incorporate corrections or adjustments suggested by the system.

The term “proficiency information” refers to data representing an estimated skill level or capability of a user in a given language or domain, which may be derived from historical evaluations, performance metrics, or user profiles.

The term “evaluation result information” refers to structured or unstructured data derived from analyzing a user's utterance, including scores, qualitative assessments, and categorical labels for language quality and logical consistency.

The term “length of utterance content” refers to a magnitude characteristic of a prompt sentence or user utterance, such as word count, sentence count, or overall text size, which can be adjusted by the system.

The term “difficulty of utterance content” refers to a complexity characteristic of a prompt sentence or user utterance, including vocabulary sophistication, grammatical complexity, or conceptual challenge.

The term “depth of discussion points” refers to a level of analytical or conceptual detail required or encouraged in a user's utterance, including the number of arguments, counterarguments, and supporting examples expected in a debate.

In one embodiment, a server, one or more terminal devices, and a user cooperate to implement the claimed system. The server includes at least one hardware processor, a main memory, a non-volatile storage device, and a network interface. The terminal includes a hardware processor, a memory, a display, an audio input device such as a microphone, an audio output device such as a speaker, and a network interface. The user operates the terminal to participate in debate-based language training that is managed by the server.

The server executes software components including an operating system, a web server, an application server, a database management system, a natural language processing library, a speech recognition client, and a generative AI model client. The server uses a general-purpose processor architecture, such as a multi-core central processing unit, and may also use an accelerator, such as a graphics processing unit, for neural network inference. The terminal executes an operating system, a client application, and drivers for audio input and output.

The server retrieves text information from one or more information sources. The server uses communication software, for example an HTTP client library, to send requests to network-accessible content delivery services or data storage systems. The server receives responses in formats such as hypertext markup or structured text, and the server parses these responses using a text processing library to extract article bodies, titles, and metadata. The server normalizes character encodings and removes non-content elements to obtain cleaned text information. The server stores the cleaned text information in a relational or key-value data store as records comprising fields such as an identifier, a title, a body, a source label, a timestamp, and a language code.

The server generates summary information and debate-theme information from the stored text information. The server uses a generative AI model that is implemented as a transformer-based neural network with multiple attention layers, feedforward layers, and layer normalization. The generative AI model is pre-trained on large amounts of text data and optionally fine-tuned on debate-oriented corpora. The server provides the text information as part of an input sequence to the generative AI model by constructing a prompt sentence. The server structures the prompt sentence so that it includes an instruction section and a content section. For example, the server generates a prompt sentence such as:
“Read the following news article and then perform two tasks:
1) Provide a concise summary in 3-4 sentences.
2) Propose three debate themes in English that a language learner could discuss.
Article:
[ARTICLE_TEXT]”

The server feeds a tokenized representation of this prompt sentence into the generative AI model. The model processes the tokens using its attention mechanism, where each layer computes attention weights between tokens based on learned parameter matrices and computes contextualized representations. The server decodes the output token probabilities to produce output text. The server then extracts the portion corresponding to the summary information and the portion corresponding to the debate-theme information. The server stores the summary information and debate-theme information in association with the underlying article record in the storage device.

The server uses the generative AI model in a specialized configuration for generating a prompt sentence that starts a debate and a prompt sentence that manages a progression of a debate. The server selects debate-theme information from the storage device and constructs an instruction that instructs the model to output a single open-ended question suitable for starting a debate. For example, the server may generate a prompt sentence such as:

“You are preparing a debate for language learners. Based on the theme: ‘The impact of climate change on global agriculture’, write one clear, open-ended English question that can start a debate.”

The server again tokenizes this prompt, inputs the tokens to the generative AI model, and decodes the output tokens to obtain a text sequence such as:

“What are the major impacts of climate change on global agriculture?”

The server stores this generated debate-start prompt sentence as associated data with the debate-theme information.

The server also uses the generative AI model to generate one or more prompt sentences that manage the progression of an ongoing debate. The server maintains a conversation context data structure, in which the server stores a sequence of user utterances and system utterances with associated timestamps and roles. The server constructs a composite input string that includes the debate-theme information, the recent conversation context, and an instruction to provide a follow-up question or counterpoint. The server uses this composite input as a prompt sentence to the generative AI model. The model outputs a new moderator utterance, for example a follow-up question, which the server stores and sends to the terminal. By using a structured context representation and role annotations, the server enables the generative AI model to maintain coherent debate progression without recalculating context from scratch at each interaction, thereby reducing processing load and network usage.

The terminal receives debate-theme information and a debate-start prompt sentence from the server via a network connection. The terminal displays the debate-theme information and the debate-start prompt sentence on a graphical user interface. The terminal allows the user to initiate participation by activating an audio recording function. The user reads the displayed debate-theme information, for example “The impact of climate change on global agriculture.”, and the debate-start prompt sentence, for example “What are the major impacts of climate change on global agriculture?”, and then the user decides on an initial opinion.

The user speaks an utterance into the microphone of the terminal, for example:

“Climate change affects agriculture by altering rainfall patterns and increasing the frequency of extreme weather events.”

The terminal captures this utterance as audio information through audio capture software. The terminal uses operating system audio APIs to sample the analog voice signal into digital audio frames at a specified sample rate and bit depth. The terminal stores the audio frames in a buffer in main memory and may encode them into a compressed audio format. The terminal associates metadata such as a user identifier, a session identifier, and a timestamp with the stored audio information.

The terminal converts the audio information into character information by invoking a speech recognition component. The terminal may call a remote speech recognition service or execute a local speech recognition engine. In one embodiment, the terminal uses a neural network-based automatic speech recognition model that maps sequences of acoustic feature vectors to sequences of text tokens. The terminal computes features such as Mel-frequency cepstral coefficients for each frame, and the speech recognition model processes these features through recurrent or transformer layers to produce probability distributions over text tokens.

The terminal decodes the probabilities using an algorithm such as beam search to produce the most likely transcription. The resulting character information, which represents the user's utterance, is then packaged with the associated metadata and sent to the server over the network.

The server receives the character information and associates it with the corresponding debate-theme information and the user's conversation context. The server uses the generative AI model, together with auxiliary natural language processing modules, to analyze the character information. The server constructs a detailed evaluation prompt sentence that encodes the debate-theme information, the user's utterance, and explicit analysis instructions. For example, the server generates a prompt sentence such as:
“Evaluate the following statement from an English learner in the context of a debate.
Debate theme: ‘The impact of climate change on global agriculture.’
Learner's statement:
‘Climate change affects agriculture by altering rainfall patterns and increasing the frequency of extreme weather events.’

### Tasks:

1) Identify strengths in grammar and vocabulary.
2) Point out any grammatical errors or awkward phrases.
3) Comment on the logical clarity and completeness of the idea.
4) Provide concise, practical feedback with at least one suggestion for improvement.”

The server tokenizes this prompt sentence and inputs it into the generative AI model. Internally, the model computes contextual representations for each token. The model has learned parameters, which were obtained during training by minimizing a loss function such as cross-entropy between predicted token distributions and ground-truth token sequences. During training, the model parameters, including attention weight matrices and feedforward network weights, were updated by gradient descent using backpropagation. The server does not re-train the model during inference, but the server benefits from the learned structure that can evaluate language quality and logical consistency in context.

The server post-processes the generative AI model's output by parsing the text into structured components representing favorable points, improvement points, and an overall assessment. The server may also complement the model output with rule-based checks implemented using a natural language processing library. For example, the server may run a grammar checker on the character information and cross-validate the suggestions from the generative model with the rule-based findings. The server aggregates these results in a feedback information data structure that includes labeled fields for “Good points” and “Suggestions for improvement.” The server generates feedback information such as:
“Good points: The phrase ‘altering rainfall patterns’ is specific and appropriate. You use the present simple correctly to describe a general effect.
Suggestions for improvement: The phrase ‘increasing the frequency of extreme weather events’ could be made more concrete. You could add specific examples, such as ‘more frequent droughts and floods,’ to clarify your point.”

The server transmits this feedback information to the terminal. The terminal receives the feedback information and presents it to the user via visual display and optionally via audio output. The terminal updates a display area with headings such as “Good points” and “Suggestions for improvement,” and renders the feedback sentences in a readable format. The terminal may invoke a text-to-speech engine to synthesize audio signals corresponding to the feedback information and play these signals through the speaker, thereby enabling multimodal feedback.

The server maintains a speech history for each user, which includes the transcribed utterances, the debate-theme information associated with each utterance, and the evaluation result information derived from the generative AI model and auxiliary analyzers. The server stores this history as records linked to a user profile in the database. Each record may contain fields such as utterance text, grammatical error counts, vocabulary diversity measures, logical coherence scores, and timestamps.

The server uses the speech history and the evaluation result information to compute proficiency information for the user. The server may compute numerical indicators such as an estimated grammar proficiency level, a vocabulary breadth index, and a logical reasoning score. The server may calculate these indicators using statistical methods or learned mappings from features extracted from the history. For example, the server may use the frequency of specific error categories and the progression of scores over time as input to a predictive model that estimates a proficiency level.

The server uses the proficiency information and the evaluation result information to adjust subsequent prompt sentences. The server modifies parameters such as target length, lexical complexity, and required depth of discussion. The server may maintain a template representation of prompt sentences, where each template includes variables for these parameters. The server selects or modifies a template based on the user's current proficiency profile. The server then instantiates the template into a concrete prompt sentence and provides it to the generative AI model to produce a refined question or instruction. In this way, the system does not simply repeat generic prompts; instead, it adjusts the computational behavior of the generative AI model through engineered inputs, thereby controlling the difficulty and focus of the generated utterances in a way that would be impractical to perform manually for each interaction.

The server thereby improves technical performance of the overall system. Because the server stores and reuses structured context, summary information, and debate-theme information, the server avoids repeatedly requesting and processing the full original articles for each debate session, reducing network traffic and processing time. Because the server uses a transformer-based generative AI model with a well-defined input prompt encoding, the server can simultaneously perform content generation and evaluation tasks using a single model invocation rather than multiple separate rule-based engines, thereby reducing latency.

Because the server tailors prompt sentences based on user history and proficiency, the server can maintain an appropriate difficulty level, which reduces the number of iterations needed for the user to obtain meaningful feedback, further lowering computational load over time. The described implementation is not a mere automation of a manual teaching procedure. A human instructor typically cannot process continuous speech streams from multiple users, maintain structured speech histories with detailed linguistic and logical metrics, and generate customized prompts and feedback in real time based on long-term performance statistics. The server, however, can perform these operations consistently and efficiently through dedicated data structures, algorithmic flows, and neural network inference that operate at machine speed and scale. The causal relationship between the use of the generative AI model, the structured processing pipeline, and the observed technical effects is clear: the cooperation of prompt design, context management, and adaptive difficulty control enables reduced response time, improved accuracy of transcription-based evaluation, decreased communication overhead, and more efficient use of processing resources.

In alternative embodiments, the server may execute the generative AI model on different hardware accelerators, and the terminal may run partial models locally to offload certain tasks. In one variation, the terminal executes a smaller speech recognition model locally to produce a first-pass transcription, and the server refines or verifies the transcription using an additional language model. In another variation, the server uses a separate discriminative neural network to estimate a confidence score for each feedback item; low-confidence items may be suppressed or marked, which improves reliability and reduces noise in the feedback presented to the user. In still another embodiment, the server may batch process multiple users' evaluation requests by grouping similar debate themes and reusing intermediate transformer layer outputs, thereby further improving computational efficiency.

In all these embodiments, the server, the terminal, and the user cooperate in a tightly integrated system. The server performs content acquisition, summarization, debate management, speech history analysis, and adaptive prompt generation using specific computational models and data structures. The terminal performs audio capture, speech recognition interfacing, and multimodal feedback display. The user interacts by reading prompt sentences, speaking utterances, and reviewing feedback. The system as a whole improves the functioning of the underlying computing environment by optimizing data flow, reducing redundant computation, and enabling context-aware, adaptive processing that would not be achievable with simple rule-based or static program logic.

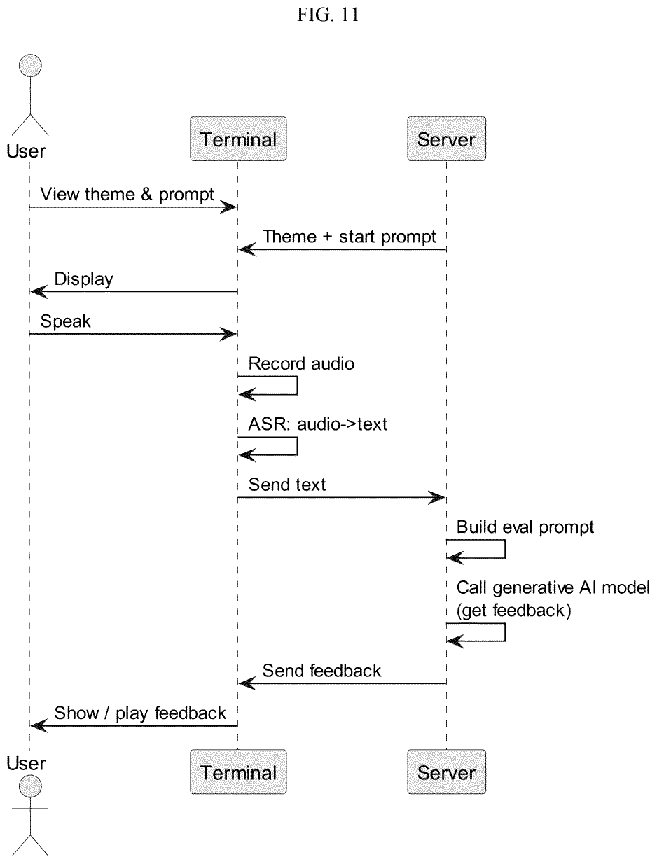

The following describes the processing flow using FIG. 11.

### Step 1:

Server acquires raw text information from an information source.

Server receives as input one or more resource identifiers such as URLs or API endpoints stored in a configuration repository. Server sends network requests using an HTTP client and receives responses containing article data in hypertext or structured text formats. Server performs data processing by parsing the response, removing markup tags and non-content elements, normalizing character encoding, and concatenating text segments into continuous article bodies. Server outputs cleaned text information records, each including an identifier, a title field, a body text field, and metadata fields, and stores these records in a storage subsystem.

### Step 2:

Server generates summary information and debate-theme information from the cleaned text information.

Server receives as input one or more article body texts and associated metadata from the storage subsystem. Server constructs a prompt sentence that includes an instruction section and a content section embedding the article text, for example:
“Read the following news article and then perform two tasks:
1) Provide a concise summary in 3-4 sentences.
2) Propose three debate themes in English that a language learner could discuss.
Article:
[ARTICLE_TEXT]”

Server tokenizes this prompt sentence into token identifiers and feeds the tokens into a transformer-based generative AI model. Server performs data computation by propagating the tokens through attention layers and feedforward layers of the model to obtain output token probability distributions, and then decodes these probabilities into output text. Server parses the output text to separate a condensed representation as summary information and one or more topic phrases as debate-theme information. Server outputs and stores the summary information and debate-theme information in association with the corresponding article records.

### Step 3:

Server generates a debate-start prompt sentence based on the debate-theme information.

Server receives as input the selected debate-theme information, such as a textual description of a topic. Server builds an instruction prompt sentence that requests an open-ended debate question, for example:
“You are preparing a debate for language learners. Based on the theme: ‘The impact of climate change on global agriculture’, write one clear, open-ended English question that can start a debate.”
Server tokenizes this instruction, processes the tokens through the same generative AI model, and applies decoding to obtain a text output such as:
“What are the major impacts of climate change on global agriculture?” Server outputs this generated debate-start prompt sentence and stores it in a prompt repository linked to the debate-theme information.

### Step 4:

Server prepares debate-session data and transmits theme and prompt information to the terminal.

Server receives as input a session creation request that specifies a user identifier or a terminal identifier. Server selects appropriate debate-theme information and the corresponding debate-start prompt sentence from the storage subsystem. Server composes a structured response including fields for the theme text, the prompt sentence, and a session identifier. Server outputs this data via a network interface as a response message to the terminal.

### Step 5:

Terminal receives and displays the debate-theme information and debate-start prompt sentence.

Terminal receives as input the response message from the server containing the debate-theme text, the debate-start prompt sentence, and the session identifier. Terminal parses the message, extracts the relevant text fields, and stores them in local memory as current session state. Terminal performs data processing by mapping these text fields to graphical user interface elements, updating the display with the debate-theme text as a heading and the debate-start prompt sentence as a question shown below it. Terminal outputs a rendered user interface that the user can visually perceive.

### Step 6:

User reads the displayed debate-theme information and debate-start prompt sentence and formulates an opinion.

User receives as input the textual display on the terminal screen, including the debate topic and the initial question. User performs mental processing by understanding the content and deciding on one or more arguments or examples to present. User outputs a planned spoken utterance in natural language, prepared for oral delivery.

### Step 7:

User provides an utterance related to the debate-theme information.

User receives as input the display and any instructions on the terminal interface, such as a message indicating that recording is ready. User initiates recording by interacting with the terminal interface, for example by tapping a microphone icon, and then speaks an utterance such as:
“Climate change affects agriculture by altering rainfall patterns and increasing the frequency of extreme weather events.”

User produces as output an acoustic speech signal directed to the terminal's microphone.

### Step 8:

Terminal captures the acoustic speech signal and converts it into audio information.

Terminal receives as input the analog speech signal from the microphone hardware. Terminal uses audio capture APIs to sample the signal at a defined sampling rate and bit depth, thereby performing an analog-to-digital conversion. Terminal packs the sampled data into audio frames and may perform encoding into a compressed format. Terminal associates the resulting audio information with the current session identifier and a timestamp. Terminal outputs a digital audio data stream representing the user's utterance, stored in memory or a temporary file.

### Step 9:

Terminal converts the audio information into character information using speech recognition processing.

Terminal receives as input the audio data stream corresponding to the user's utterance and configuration parameters such as language code. Terminal calls a speech recognition component that computes acoustic features for each frame and feeds them into an acoustic-linguistic neural network, which outputs token probabilities over a vocabulary. Terminal performs decoding, for example using beam search, to select the most probable sequence of text tokens. Terminal concatenates these tokens into a character string such as:
“Climate change affects agriculture by altering rainfall patterns and increasing the frequency of extreme weather events.”

Terminal associates the string with metadata such as the user identifier and session identifier.

Terminal outputs the resulting character information and transmits it to the server over the network.

### Step 10:

Server receives the character information and retrieves the corresponding debate context.

Server receives as input a message from the terminal that includes the character information, user identifier, and session identifier. Server uses the session identifier to access session records in the storage subsystem. Server retrieves the debate-theme information, the debate-start prompt sentence, and any prior utterances in the conversation context. Server outputs a structured context object that combines the current user utterance and the relevant debate context data.

### Step 11:

Server constructs an evaluation prompt sentence and analyzes the character information using the generative AI model.

Server receives as input the structured context object containing the debate-theme information and the user's utterance. Server builds an evaluation prompt sentence that includes the theme, the utterance, and explicit evaluation tasks, for example:
“Evaluate the following statement from an English learner in the context of a debate.
Debate theme: ‘The impact of climate change on global agriculture.’
Learner's statement:
‘Climate change affects agriculture by altering rainfall patterns and increasing the frequency of extreme weather events.’

### Tasks:

1) Identify strengths in grammar and vocabulary.
2) Point out any grammatical errors or awkward phrases.
3) Comment on the logical clarity and completeness of the idea.
4) Provide concise, practical feedback with at least one suggestion for improvement.” Server tokenizes this prompt sentence and feeds the tokens into the generative AI model.

Server performs computational operations within the model, including attention-weight calculation, context vector computation, and output token probability prediction. Server decodes the output to produce an evaluation text that describes favorable points, improvement points, and overall commentary. Server outputs this evaluation text for further structuring.

### Step 12:

Server structures the evaluation text into feedback information and stores evaluation result information.

Server receives as input the raw evaluation text from the generative AI model. Server performs data processing by scanning for section indicators such as “Good points” and “Suggestions for improvement,” or by applying pattern-matching rules to segment the content. Server extracts phrases that correspond to positive assessments and suggested corrections or elaborations. Server maps these segments into a feedback data structure with fields for favorable points, improvement points, and an overall comment. Server also updates a speech history record for the user, storing the utterance text together with computed metrics or scores derived from the evaluation text. Server outputs the structured feedback information and persists the updated evaluation result information in the storage subsystem.

### Step 13:

Server sends the feedback information to the terminal.

Server receives as input the structured feedback information along with identifiers for the target user and session. Server composes a response message formatted for the terminal, including textual fields for each feedback section. Server transmits this message over the network to the terminal's network address. Server outputs the sent message and may log transmission status for reliability tracking.

### Step 14:

Terminal presents the feedback information to the user in visual and optionally audio form.

Terminal receives as input the feedback message containing favorable points, improvement points, and overall comment. Terminal parses the message into separate text segments and updates local state. Terminal performs data processing by mapping each feedback segment to a user interface component, such as headings and body text areas. Terminal displays the favorable points and improvement points in distinct sections on the screen, for example labeling them “Good points” and “Suggestions for improvement.” Terminal may additionally convert the entire feedback text into synthetic speech using a text-to-speech engine, thereby producing audio output corresponding to the feedback information. Terminal outputs a multimodal presentation that the user can see and optionally hear.

### Step 15:

User reviews the feedback information and decides on a revised utterance.

User receives as input the visual display of feedback and, when enabled, the spoken rendition of the feedback. User reads or listens to the indications of strengths and suggestions. User performs cognitive processing by identifying specific grammar, vocabulary, or logical issues to modify. User constructs a revised opinion or an expanded explanation that integrates the suggested improvements, for example by preparing to add concrete examples such as “more frequent droughts and floods that damage crops.” User outputs a new internal plan for a re-utterance to be spoken in a subsequent recording cycle.

### Step 16:

Server updates proficiency information and adjusts subsequent prompt sentences based on the speech history.

Server receives as input the updated speech history and evaluation result information for the user after one or more utterances. Server computes proficiency information by aggregating features such as average error count, vocabulary variety, and logical coherence indicators over multiple sessions. Server performs data processing by applying statistical calculations or a learned mapping to derive estimates of the user's grammar proficiency, lexical level, and reasoning ability. Server then uses this proficiency information to determine adjustment parameters for future prompt sentences, such as target length, complexity of vocabulary, or required depth of argumentation. Server modifies control variables in prompt templates and constructs adjusted instruction texts for the generative AI model. Server outputs these adjusted prompt sentences for subsequent debate sessions, allowing the system to progressively refine the difficulty and focus of prompts for that user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented language training systems generally provide static exercises, pre-authored questions, and batch feedback that is computed only after a learner has completed an entire session. Such systems typically do not treat debate sessions as dynamic, multi-user, time-series data streams, and therefore do not exploit fine-grained linguistic analysis and adaptive prompt generation in real time. As a result, the underlying computing functionality remains limited to simple text presentation, fixed scoring, and non-adaptive content selection, which restricts both system responsiveness and the precision of feedback.

In many existing implementations, a processor merely displays news articles or predefined topics, accepts user input, and performs basic keyword matching or simple grammar checks. These architectures do not integrate multiple specialized components-such as a generative AI model, a natural language processing engine, and a speech recognition module-into a coordinated feedback loop that continuously adjusts debate prompts based on computed linguistic metrics and historical performance. Because of this, the computer system is not optimized for managing multi-user debate flows, generating context-aware prompt sentences, or transforming raw utterance data into structured evaluation signals that can be reused by the system to improve subsequent interactions.

Furthermore, conventional systems generally lack mechanisms for treating user utterances as structured, persistent data objects enriched with syntactic data, lexical data, discourse-structure data, and time-series statistics. Without such internal representations, the processor cannot efficiently compute vocabulary-diversity data, sentence-length statistical data, or logical-connector usage-frequency data at scale. This limitation prevents the system from building reliable, long-term learning profiles and from using such profiles as input conditions to dynamically control the topic, difficulty level, and utterance format of newly generated prompt sentences.

Another technical problem arises in coordinating multiple user terminals in a live debate. Prior systems either rely on manual moderation or simple turn-taking rules that are not generated or adapted by machine. These systems do not allow the processor itself to function as a debate moderator that autonomously generates follow-up prompt sentences according to the evolving debate state. Consequently, the information processing apparatus cannot fully leverage its processing capabilities to maintain coherent discussion flow, manage time-series utterance data from multiple users, and adjust subsequent system outputs in a way that improves both processing efficiency and user interaction quality.

Therefore, there is a need for an improved computer-implemented system in which a processor is specifically configured to (i) acquire and structure article data from information sources, (ii) analyze user utterances with a natural language processing engine to obtain rich linguistic feature data, (iii) compute evaluation data and long-term learning-trend data from that feature data, and (iv) use a generative AI model in a closed loop to generate adaptive prompt sentences and feedback based on session history and user attributes. Such a system improves the operation of the computer itself by enabling new internal data flows, new forms of state-dependent content generation, and more efficient management of multi-user debate sessions.

The specific processing by the specific processing unit 290 of the data processing device 12 in Application Example 1 is realized by the following means.

The present invention provides a server comprising a processor that is configured to acquire information distributed from an information providing medium and store the information as character data in a storage device; analyze the stored character data to extract abstract topic data and related term data; generate, by using a generative AI model, prompt sentences including a plurality of debate instruction sentences on the basis of the extracted topic data and related term data; convert voice data of a user, which is transmitted from a user terminal, into character data by using a speech recognition device, and analyze the character data as syntactic data, lexical data, and discourse-structure data by using a natural language processing device; calculate evaluation data indicating quality data of language data used in a debate, correctness data of sentence construction, and validity data of logical construction on the basis of the analyzed syntactic data, lexical data, and discourse-structure data; generate learning-support feedback data including misuse-expression data, improvement-candidate-expression data, and favorable-expression data on the basis of the calculated evaluation data; store the generated learning-support feedback data in association with session data and user identification data; dynamically adjust content, difficulty level, and topic selection of the prompt sentences in a subsequent debate session on the basis of a storage result; manage utterance data acquired from a plurality of user terminals together with time-series data and speaker-identification data; and function as a debate moderator by generating, by using the generative AI model, follow-up prompt sentences according to debate progress and distributing the follow-up prompt sentences to the plurality of user terminals. This enables the computer system to internally transform raw article data and raw utterance data into structured linguistic and evaluation data, to use that data as control inputs for adaptive generation of prompt sentences and feedback in real time, and to autonomously coordinate multi-user debate sessions such that the operation of the server—its data management, content generation, and interaction control—is technically improved in terms of responsiveness, adaptability, and efficiency.

The term “information providing medium” refers to any data source implemented by an information processing facility that distributes textual or multimedia information, including but not limited to news feeds, databases, web services, or content distribution platforms, from which character data can be acquired by a server.

The term “character data” refers to digital data representing textual information encoded in a character set, such as letters, numbers, symbols, and punctuation, which can be stored, analyzed, and processed by an information processing apparatus.

The term “storage device” refers to any computer-readable recording medium or memory apparatus, such as a magnetic storage device, semiconductor memory, or optical storage device, that is configured to store character data, session data, user identification data, and other information used by a processor.

The term “abstract topic data” refers to structured information representing a higher-level subject or theme inferred from character data, such as a debate theme or discussion topic, which is derived by analyzing the content and semantics of acquired information.

The term “related term data” refers to data representing words, phrases, or expressions that are contextually or semantically associated with abstract topic data and that are extracted from character data for use in generating prompt sentences.

The term “generative AI model” refers to an information processing model implemented on a computing apparatus that is configured to generate new text data, such as prompt sentences or feedback sentences, on the basis of input data and learned parameters.

The term “prompt sentences” refers to text data that instructs, guides, or stimulates user utterances, including debate instruction sentences and follow-up questions, which are generated by a generative AI model and presented to users.

The term “debate instruction sentences” refers to a subset of prompt sentences that explicitly instruct a user to express an opinion, provide reasons, or respond to a specific topic or question within a debate session.

The term “user terminal” refers to any information processing apparatus operated by a user, such as a personal computer, mobile terminal, or head-mounted display, which is configured to transmit voice data or character data to a server and to receive prompt sentences and feedback.

The term “voice data” refers to audio data representing spoken utterances of a user, which is acquired by an input device such as a microphone and transmitted to a speech recognition device for conversion into character data.

The term “speech recognition device” refers to a hardware or software component implemented by an information processing apparatus that is configured to convert voice data into character data by performing automatic speech recognition processing.

The term “natural language processing device” refers to a hardware or software component implemented by an information processing apparatus that is configured to analyze character data using natural language processing techniques to obtain syntactic data, lexical data, and discourse-structure data.

The term “syntactic data” refers to structured information representing grammatical structure of character data, including part-of-speech tags, dependency relations, and sentence boundaries, which is obtained by processing text with a natural language processing device.

The term “lexical data” refers to structured information representing word-level properties of character data, including word forms, lemmas, vocabulary frequencies, and lexical diversity indicators, which is derived by analyzing text with a natural language processing device.

The term “discourse-structure data” refers to structured information representing relationships and organization between sentences or segments in character data, including discourse markers, coherence relations, and argument structure, which is identified by a natural language processing device.

The term “evaluation data” refers to data computed on the basis of syntactic data, lexical data, and discourse-structure data that indicates quality of language use, correctness of sentence construction, and validity of logical construction in user utterances.

The term “quality data of language data” refers to information within evaluation data that indicates overall appropriateness and fluency of language used in a debate, including grammatical correctness, vocabulary use, and stylistic adequacy.

The term “correctness data of sentence construction” refers to information within evaluation data that indicates whether sentence structures conform to grammatical rules, including word order, agreement, and completeness of sentences.

The term “validity data of logical construction” refers to information within evaluation data that indicates coherence and soundness of reasoning in user utterances, including presence of clear claims, supporting reasons, and logical connectors.

The term “learning-support feedback data” refers to data representing information intended to assist a user in improving language skills, including specific indications of misuse expressions, alternative expressions, and positive examples, which is generated on the basis of evaluation data.

The term “misuse-expression data” refers to data that identifies segments of user utterances that are inappropriate, ungrammatical, or unnatural and that should be corrected or avoided in future utterances.

The term “improvement-candidate-expression data” refers to data that proposes alternative expressions, reformulated sentences, or enhanced wording that can replace or supplement parts of user utterances to improve clarity, correctness, or sophistication.

The term “favorable-expression data” refers to data that identifies segments of user utterances that are evaluated as appropriate, effective, or exemplary, and that can serve as positive references for future language use.

The term “session data” refers to data representing a unit of interaction between one or more users and a server, including identifiers, timestamps, selected topics, associated prompt sentences, and utterances belonging to a particular debate session.

The term “user identification data” refers to data that uniquely or pseudonymously identifies a user in the system, such as an account identifier, terminal identifier, or session-linked identifier, which is used to associate utterances and feedback with the corresponding user.

The term “time-series data” refers to data representing temporal ordering and timing of events, such as utterances or feedback, including timestamps and sequence indices, which allows the system to process and analyze information in chronological order.

The term “speaker-identification data” refers to data that associates each utterance or voice segment with a specific user or terminal, enabling the system to distinguish between speakers in a multi-user debate.

The term “utterance data” refers to character data or structured data representing individual spoken or typed contributions made by a user during a debate session, including both the text content and associated metadata.

The term “debate moderator” refers to a functional role performed by the processor, in which the processor controls debate flow by generating and distributing follow-up prompt sentences, managing turn-taking, and adjusting content based on debate progress.

The term “follow-up prompt sentences” refers to prompt sentences generated during an ongoing debate session, which are adapted to current debate progress and are configured to deepen, redirect, or extend the discussion.

The term “vocabulary-diversity data” refers to data representing a measure of lexical variety in user utterances, such as a type-token ratio or related metric, which is computed from lexical data.

The term “sentence-length statistical data” refers to data representing statistics related to lengths of sentences in user utterances, such as average length, variance, or distribution, which is computed from syntactic data.

The term “logical-connector usage-frequency data” refers to data representing how frequently logical connectors, such as contrastive or causal expressions, are used in user utterances, which is computed from discourse-structure data.

The term “ability-estimation data” refers to data representing an estimated proficiency level of a user in one or more aspects of language use, such as grammar, vocabulary, or logical reasoning, which is derived from evaluation data and time-series statistics.

The term “long-term learning-trend data” refers to data representing temporal changes and patterns in a user's language performance across multiple sessions, including improvements or regressions in specific metrics, which is computed from stored evaluation data and time-series data.

The term “user-attribute data” refers to data representing characteristics of a user relevant to system operation, such as proficiency level, preferred language, or learning objectives, which is used as an input condition for generating customized prompt sentences.

The term “history data of past sessions” refers to stored data related to previous debate sessions involving a user, including topics, prompt sentences, utterances, evaluation data, and feedback data, which is used to control generation of new prompt sentences.

The term “customized prompt sentences” refers to prompt sentences whose topic, expression difficulty level, and utterance format are controlled or adjusted for an individual user on the basis of evaluation data, user-attribute data, and history data of past sessions.

In one embodiment, a server is implemented as an information processing apparatus including at least one processor, a main memory, a non-volatile storage device, and a network interface. The server is connected via a communication network to a plurality of terminals operated by users. Each terminal is implemented as an information processing apparatus such as a smartphone, tablet, personal computer, or head-mounted display, including at least a processor, a display device, an input device, an audio input device such as a microphone, and a communication interface.

The server stores in the non-volatile storage device a group of software modules including an operating system, a web server process, an application server process, a natural language processing module, a generative AI model inference module, a speech recognition interface module, and a database management system. The server loads a part or all of these modules into the main memory and executes them by the processor. The server uses a relational database or a key-value store as a storage layer for article data, session data, utterance data, evaluation data, feedback data, and user identification data. The server defines concrete data structures such as an article table, a session table, an utterance table, and an evaluation table, each including indexed fields for efficient retrieval.

The server receives, via the network interface, data from an information providing medium such as a news distribution service, an information feed service, or an online content repository. The server converts this incoming data into character data by parsing markup and metadata and stores the normalized character data in the article table. The server associates each article record with fields representing topic indicators, term frequency vectors, and document embeddings computed by the natural language processing module. The server thereby generates abstract topic data and related term data as internal structured representations.

The server implements the natural language processing module using software libraries that perform tokenization, part-of-speech tagging, syntactic parsing, named entity recognition, and discourse analysis. The server applies these algorithms to each article in order to compute feature vectors representing sentence boundaries, dependency structures, and significant discourse markers. The server stores some of these features as precomputed indices so that subsequent prompt generation and evaluation operations can be executed with reduced latency and reduced computational cost.

The server configures a generative AI model inference module as a neural network model that has been trained in advance on a large corpus of text data. The generative AI model is implemented, for example, as a transformer-based sequence-to-sequence neural network having multiple self-attention layers, feed-forward layers, and normalization layers. The server stores model parameters such as weight matrices and bias vectors in a model storage area and loads them into memory for inference. The server defines an input token sequence structure that encodes abstract topic data, related term data, and control tokens indicating desired output style, difficulty level, and length.

The server, when generating a prompt sentence, constructs a model input sequence including at least: tokens representing an instruction segment, tokens representing a summary of the article content, and tokens representing topic and user-level control information. The server applies positional encoding to the input tokens and propagates them through the transformer layers. The server computes attention scores between tokens, produces contextualized token embeddings, and decodes them to generate output tokens representing one or more prompt sentences. The server converts the output tokens into character data representing human-readable text. The server thereby generates prompt sentences that are context-aware and tailored to debate instruction.

The server sets hyperparameters of the generative AI model, such as the number of layers, hidden size, attention heads, vocabulary size, and maximum sequence length, to balance inference speed and language quality. The server configures decoding methods such as top-k sampling or nucleus sampling, and temperature scaling, to control diversity and determinism of generated prompt sentences. The server may adjust these decoding parameters based on evaluation data for a given user so that the complexity and openness of debate instruction sentences can be systematically increased or decreased.

The server implements a speech recognition interface module that communicates with a speech recognition device. The terminal acquires voice data from the user via the microphone and transmits the voice data to the server or directly to the speech recognition device. The speech recognition device converts the acoustic signal into character data using an acoustic model and a language model. The server receives the recognition result and stores the character data as utterance data. The server associates each utterance data node with session data, user identification data, time-series data, and speaker-identification data.

The server applies the natural language processing module to the utterance data in order to compute syntactic data, lexical data, and discourse-structure data. The server uses these data structures as feature vectors for computing evaluation data. The server, for example, counts syntactic error patterns, checks subject-verb agreement, measures sentence length distributions, and detects logical connectors. The server computes vocabulary-diversity measures such as type-token ratio and lexical sophistication indices by generating term frequency distributions for each utterance and for aggregated utterances in a session.

The server uses a dedicated evaluation module that receives as input the syntactic data, lexical data, discourse-structure data, and vocabulary-diversity measures and outputs evaluation scores. The evaluation module applies rule-based algorithms and statistical models. The server configures the rule-based algorithms to detect specific error patterns in dependency trees and part-of-speech sequences. The server configures the statistical models, which can be implemented as regression models or small neural networks, to map feature vectors to scalar scores representing grammar quality, vocabulary richness, and logical coherence. The server uses loss functions such as mean squared error or cross-entropy during an offline training phase to adjust the model weights so that the evaluation scores correlate with human-annotated proficiency labels.

The server stores evaluation data for each utterance in the evaluation table, associating it with the underlying utterance data and session data. The server further aggregates evaluation data along the time axis for each user in order to compute long-term learning-trend data. The server computes, for example, moving averages and exponential smoothing of scores, trend slopes for grammar and vocabulary metrics, and frequency histograms of logical connector usage. The server uses these precomputed trend metrics to reduce the computation required for generating feedback and new prompt sentences, thereby improving processing efficiency.

The server generates learning-support feedback data by combining template-based generation and generative AI-based generation. The server maintains a set of structured templates for common feedback scenarios, such as subject-verb agreement errors or lack of supporting reasons. The server fills these templates with specific phrases extracted from the utterance data. The server can also construct a second-stage input sequence to the generative AI model that includes: the user's utterance, the detected errors, the evaluation scores, and control tokens instructing the model to output short, constructive feedback. The server decodes the model output into feedback sentences. The server may combine template-based feedback and generative feedback to produce a final feedback message that is both precise and natural.

As an example, the server may generate the following prompt sentences:
“You are a debate topic generator for language learners. Read the following news article and propose three engaging discussion prompts in English, suitable for intermediate learners.

Each prompt should encourage participants to express opinions, provide reasons, and potentially disagree with others.”
“Based on the latest news about climate change, discuss whether developed countries should bear more responsibility than developing countries in reducing emissions. Explain your reasoning with at least two arguments.”

The server may generate feedback instructions such as:
“You are an English language tutor. A learner wrote the following answer to a debate prompt. Evaluate grammar, vocabulary, and logical structure. Then produce three short suggestions for improvement and highlight one expression that is particularly good. Use a supportive and concise tone.”

The terminal displays the prompt sentences generated by the server on the display device, for example in a chat-style user interface. The user reads the prompt sentence and provides an utterance by speaking into the microphone or typing into an input field. The terminal transmits the resulting voice data or character data to the server. The terminal displays feedback sentences and evaluation scores returned by the server. The terminal may represent evaluation data using progress bars, color-coding, or other graphical indicators, thereby providing an intuitive visualization of language performance over time.

The server coordinates multiple terminals in a shared debate session by using session data structures that include identifiers of participating users, associated article data, and a chronological list of utterance data. The server maintains a turn management structure that stores, for each session, a pointer to the last speaker and a list of eligible next speakers. The server uses evaluation data and participation frequency to adjust turn-taking rules, for example by giving more speaking opportunities to users who have not spoken recently. The server can generate follow-up prompt sentences by encoding the current debate transcript and session state into the generative AI model input and instructing the model to create questions that deepen or redirect the debate. Because the follow-up prompt sentences are generated from structured transcript data rather than static templates, the server can maintain topic coherence while responding to the evolving logical structure of the discussion.

The server improves computer technology in several ways. First, the server introduces a specific internal data model that links article data, topic data, term data, utterance data, and evaluation data via indexed identifiers and time-series keys. This structure enables the processor to perform query operations and aggregation operations in sub-linear time with respect to the total number of stored sessions, thereby reducing response latency when generating adaptive prompt sentences. Second, the server precomputes and caches document and user embeddings in vector form, for example using a transformer encoder or word embedding model, and uses approximate nearest neighbor search algorithms to select articles and topics efficiently. This reduces computational load and network traffic because fewer external calls and fewer full-text operations are required.

Third, the server's evaluation module uses machine-learned models with optimized parameters to map high-dimensional linguistic feature vectors to compact evaluation scores. The server thereby transforms large volumes of textual data into low-dimensional, structured control signals that can be processed efficiently. This transformation reduces memory usage and improves throughput of the generative AI model, because the model receives summarized evaluation signals rather than raw text for adaptation. Fourth, the server's combination of rule-based error detection and neural scoring yields more stable and interpretable evaluation results than human manual grading or simple keyword checking, thereby improving accuracy and reducing variance of feedback.

The generative AI model is trained in advance by the server or an external training system. During training, the model receives input-output pairs representing instructions and desired prompt or feedback sentences. The model minimizes a loss function such as cross-entropy between predicted token sequences and target sequences. The model updates its parameters using gradient-based optimization algorithms such as stochastic gradient descent or Adam.

The training process may include data augmentation methods such as paraphrasing or random masking of tokens, which improve model robustness to variations in input. The server stores the resulting model parameters and, during inference, uses them in a read-only manner to generate prompt sentences and feedback. Because the model has been trained to interpret explicit control tokens corresponding to topic, difficulty level, and utterance format, the server can control these aspects through parameterized inputs without retraining the model.

The server uses non-conventional processing rules and flow control that differ from human moderation. For example, the server can assign numerical weights to different types of errors and use these weights to prioritize topics in subsequent prompt sentences. When the evaluation module detects persistent weaknesses in logical connectors, the server increases the probability that the generative AI model will produce prompt sentences explicitly requiring contrastive reasoning. This feedback loop is implemented by modifying the control tokens and input vectors passed to the generative AI model. The server also applies optimization strategies such as batching of utterance evaluation and prompt generation operations, caching of intermediate embeddings, and incremental update of trend metrics. These techniques reduce the number of repeated computations and lower communication overhead between modules, thereby improving throughput and system scalability.

In another embodiment, the server may use different neural network architectures for the generative AI model, such as encoder-decoder models, recurrent neural networks, or hybrid models that combine convolutional and attention layers. The server may also vary the feature sets used for evaluation, for example by incorporating prosodic features derived from audio, or by including semantic similarity scores computed from sentence embeddings. In yet another embodiment, the server may deploy the generative AI model on a dedicated accelerator device, such as a graphics processing unit or a tensor processing unit, thereby further improving inference speed.

The terminals may vary in form factor and capabilities. A terminal implemented as a head-mounted display can overlay prompt sentences and feedback in a mixed reality environment, while a mobile terminal can provide haptic feedback corresponding to evaluation scores. In all cases, the terminal communicates with the server using a secure communication protocol and maintains local caches of recent prompt sentences and feedback to minimize redisplay latency.

Because the server integrates structured data models, advanced neural network inference, specialized evaluation algorithms, and multi-terminal session management into a unified architecture, the system does not merely automate a human instructor's behavior. Instead, the system improves core aspects of computer operation, including storage design for time-series linguistic data, real-time generation of control signals for a generative AI model, and adaptive management of networked debate sessions. These technical improvements result in reductions in processing time for generating context-appropriate prompt sentences, improved accuracy and consistency of language evaluation, more efficient utilization of computing resources, and reduced communication overhead between the server and terminals.

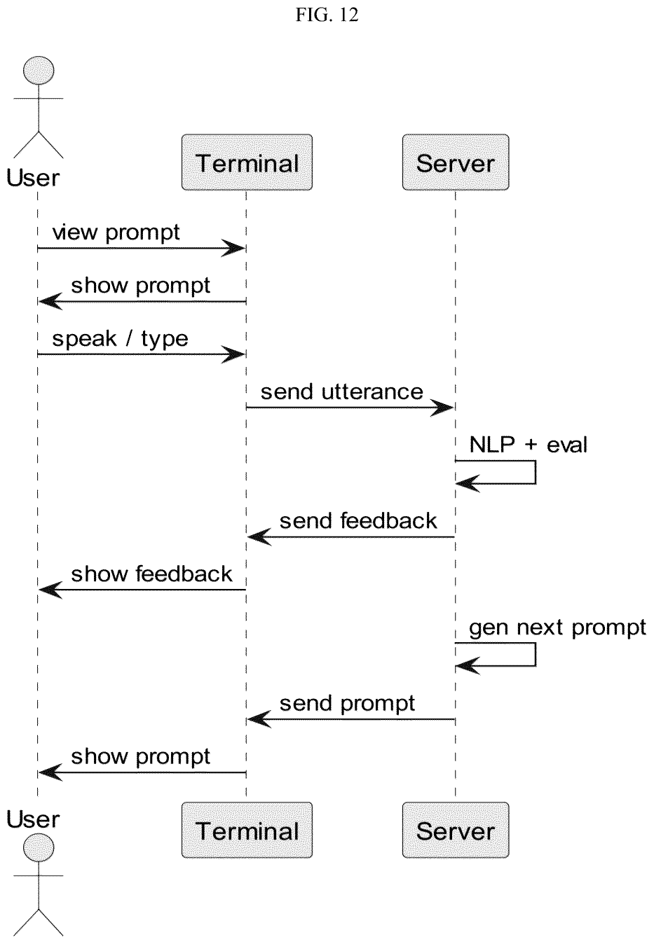

The following describes the processing flow using FIG. 12.

### Step 1:

The server acquires information from an information providing medium and normalizes it as article data.

The server receives, as input, raw data such as news feeds or content streams transmitted over a network.

The server parses the raw data to extract fields such as title, body text, timestamp, and category, and converts markup or encoded symbols into plain character data.

The server stores, as output, normalized article records in a storage device, each record including character data, topic indicators, and identifiers that can be referenced in later processing.

### Step 2:

The server performs linguistic analysis on the stored article data and generates abstract topic data and related term data.

The server receives, as input, character data from one or more article records retrieved from the storage device.

The server applies tokenization, part-of-speech tagging, syntactic parsing, and term frequency analysis to the character data, and computes feature vectors such as term frequency-inverse document frequency values and document embeddings.

The server outputs abstract topic data representing main themes and related term data representing contextually important words and phrases, and associates these outputs with the corresponding article identifiers.

### Step 3:

The server prepares model input sequences and generates initial prompt sentences using a generative AI model.

The server receives, as input, the abstract topic data, related term data, and selected article metadata.

The server constructs a token sequence that encodes an instruction segment, a condensed representation of article content, and control tokens for difficulty level and style, and then feeds this token sequence into a neural network-based generative AI model.

The server executes forward propagation through multiple transformer layers to compute attention scores and contextualized embeddings and decodes the resulting output tokens into character data.

The server outputs one or more prompt sentences that instruct users to participate in a debate on the article's topic.

### Step 4:

The terminal obtains the list of generated prompt sentences from the server and displays them to the user.

The terminal receives, as input, a response message from the server containing prompt sentences and associated session identifiers.

The terminal parses the message, selects at least one main prompt sentence, and renders it on a display as readable text in a designated user interface region.

The terminal outputs a user-visible screen that shows the prompt sentence and interaction controls such as buttons or text fields.

### Step 5:

The user reads the displayed prompt sentence and provides an utterance via voice or text input.

The user receives, as input, the prompt sentence shown on the terminal display.

The user formulates a response to the question or instruction in the prompt sentence and then speaks into a microphone or types into an input field.

The user outputs spoken audio or entered text that expresses an opinion, reasons, or arguments related to the prompt sentence.

### Step 6:

The terminal captures the user's utterance and converts it into character data suitable for server-side processing.

The terminal receives, as input, either raw audio data from the microphone or directly typed text from the user interface.

The terminal, when audio is used, transmits the voice data to a speech recognition device or service, receives recognized text as character data, and optionally allows the user to confirm or edit the text.

The terminal outputs a structured message containing the character data of the utterance, together with session identifiers, timestamps, and user-identification information, and sends this message to the server.

### Step 7:

The server stores the utterance data and enriches it with session and speaker context.

The server receives, as input, a message containing the utterance character data, session identifier, timestamp, and user-identification information from the terminal.

The server writes the utterance character data into an utterance table, associates it with the session data and user identification data, and appends time-series information and speaker-identification data.

The server outputs updated session records in which the new utterance data is appended to the chronological debate history.

### Step 8:

The server performs natural language processing on the utterance data and generates syntactic data, lexical data, and discourse-structure data.

The server receives, as input, the utterance character data associated with a particular session.

The server applies tokenization to segment the text into tokens, detects sentence boundaries, assigns part-of-speech tags, and constructs dependency trees to represent grammatical relations.

The server computes lexical features such as word lemmas, frequency counts, and type-token ratios.

The server analyzes discourse markers and co-reference cues to infer discourse-structure data such as contrast relationships, causal links, and example introduction.

The server outputs syntactic data, lexical data, and discourse-structure data as structured feature sets associated with the utterance.

### Step 9:

The server calculates evaluation data indicating language quality, sentence correctness, and logical validity based on the analyzed linguistic data.

The server receives, as input, the syntactic data, lexical data, and discourse-structure data for one or more utterances.

The server applies rule-based checks to detect specific grammar issues, such as subject-verb disagreement, incorrect article use, and incomplete sentences, and counts occurrences of such patterns.

The server computes numerical metrics for vocabulary diversity and sentence-length distribution, and measures the frequency and type of logical connectors used.

The server feeds a feature vector constructed from these metrics and counts into a scoring algorithm, which may include regression models or classification models, and obtains scalar scores for grammar quality, vocabulary richness, and logical coherence.

The server outputs evaluation data that includes these scores and structured annotations of detected errors and strengths.

### Step 10:

The server generates learning-support feedback data including misuse-expression information, improvement-candidate expressions, and favorable expressions.

The server receives, as input, the evaluation data together with the original utterance character data.

The server selects specific segments of the utterance corresponding to detected errors and maps them to feedback templates or constructs a secondary model input sequence for the generative AI model that describes the errors and requested feedback format.

The server, when using templates, fills variable portions of the templates with concrete phrases from the utterance; when using the generative AI model, decodes model output tokens into feedback sentences.

The server aggregates individual feedback elements into a coherent feedback message that identifies misuse expressions, proposes alternative expressions, and highlights examples of effective language use.

The server outputs learning-support feedback data linked to the corresponding session and user.

### Step 11:

The server updates session history and long-term user profiles based on the new evaluation data and feedback.

The server receives, as input, the evaluation data and learning-support feedback data for the latest utterance.

The server writes these data into an evaluation table and a feedback table, computes updated running statistics such as moving averages of scores and cumulative distributions of connector usage, and updates long-term learning-trend data for the user.

The server outputs revised user profile data and updated session records that include the latest evaluation and feedback information.

### Step 12:

The server generates follow-up prompt sentences adapted to debate progress and user performance using the generative AI model.

The server receives, as input, the current session transcript, evaluation data across multiple utterances, and updated user profile data.

The server constructs a model input sequence that encodes the debate context, including previous prompt sentences, summarized user arguments, and control tokens derived from evaluation trends such as desired difficulty adjustments or focus areas (for example, logical reasoning).

The server executes inference in the generative AI model to produce new output token sequences and decodes them into character data representing follow-up prompt sentences.

The server outputs follow-up prompt sentences that are context-aware and tailored to guide the next phase of the debate.

### Step 13:

The terminal receives the follow-up prompt sentences from the server and presents them to all participating users.

The terminal receives, as input, a server message containing follow-up prompt sentences and updated session state information.

The terminal parses the message, updates its internal representation of the debate state, and refreshes the display so that the new follow-up prompt sentences appear in the user interface for each participant.

The terminal outputs updated visual content that invites the users to respond to the follow-up prompt sentences and continue the debate.

### Step 14:

The user reacts to the follow-up prompt sentences and continues providing utterances, allowing the system to iteratively refine evaluation and feedback.

The user receives, as input, the follow-up prompt sentences displayed on the terminal.

The user formulates new utterances that respond to the updated questions or instructions and again speaks or types through the terminal interface.

The user outputs additional language data that is sent back through the same chain of processing for analysis, evaluation, feedback generation, and profile updating, enabling continuous adaptation of prompt sentences and learning support.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented discussion systems mainly provide static conferencing functions such as text chat, audio transmission, and simple recording. These systems treat utterances as passive content and do not actively analyze, in real time, the temporal pattern and linguistic structure of the utterances to improve the behavior of the discussion-support functions themselves. As a result, when a discussion stagnates, when participation is unbalanced among users, or when users repeatedly use unclear or logically weak language, the system cannot automatically intervene with appropriate prompts, questions, or feedback that adapt to the current state of the discussion.

In existing systems that utilize machine learning or language models, the generative components are often used in a one-shot manner to produce fixed prompts or template-based questions. Such systems do not close the loop between (i) continuous measurement of discussion dynamics at the computer level (for example, utterance frequency, inter-utterance intervals, and speaker balance), and (ii) dynamic control of the input to a generative AI model (for example, context-rich prompt sentences) to generate context-appropriate activation questions and personalized guidance. Consequently, the underlying computer processes that handle discussions remain largely static and are not optimized based on real-time discussion state, leading to inefficient use of computational resources and suboptimal support for user interaction.

Furthermore, although natural language processing techniques can be used offline to evaluate grammatical correctness or logical coherence, conventional systems do not tightly integrate such linguistic evaluation with real-time generative behavior. In particular, known systems do not use per-user language evaluation results and utterance histories as structured control signals for modifying, at the processor level, future prompt sentences, question generation parameters, and message selection strategies. This lack of integration prevents the system from improving its own operation over time for each user and from adaptively tuning the computational pipeline that governs generative interventions.

Accordingly, there is a need for an improved computer-implemented discussion support system in which a processor continuously monitors and quantifies discussion progress, dynamically constructs and updates prompt sentences for a generative AI model based on this quantified state and recent linguistic content, and generates both activation questions and individualized feedback that, in turn, modify future computation. Such a system should realize a feedback loop in which the outputs of the generative AI model and the results of linguistic evaluation are fed back into the control logic of the processor, thereby improving the technical performance of the discussion support functions, such as responsiveness, relevance of generated content, and efficient utilization of computational resources.

The specific processing by the specific processing unit 290 of the data processing device 12 in Example 2 is realized by the following means.

The present invention provides a server comprising a processor configured to analyze information acquired from an external information source and extract concepts or topics, generate, by using a generative AI model, a prompt sentence based on the extracted concepts or topics and create instruction information including the prompt sentence, receive, via a communication interface, voice data or text data from a user terminal, convert the voice data into text data, analyze the text data by natural language processing, and evaluate a discussion progress state by computing, for utterances in a discussion, time information of the utterances, a number of utterances, and a speaking ratio for each speaker, determine that the discussion progress state satisfies a predetermined condition and, in response, input into the generative AI model a context-rich prompt sentence including a discussion topic, recent utterance content, and an evaluation result of the discussion progress state, obtain from the generative AI model a generated question sentence or activation message for promoting utterances, transmit the generated question sentence or activation message to the user terminal and cause the user terminal to display the generated question sentence or activation message on a discussion screen, analyze, by using the natural language processing and the generative AI model, the text data used in the discussion to evaluate grammatical correctness, semantic clarity, and logical consistency, generate, for each user, feedback information including improvement points and examples of favorable expressions, and transmit the feedback information to the user terminal and reflect the feedback information and utterance history in generation conditions of subsequent prompt sentences and question sentences so as to dynamically control, by the processor, future inputs to the generative AI model on a per-user basis. This enables the server to implement, at the computer-architecture level, a closed feedback loop in which real-time discussion metrics and linguistic evaluation results automatically adjust the content and parameters of prompt sentences supplied to the generative AI model, thereby improving the technical performance of the discussion support system, including adaptive generation of context-appropriate questions, balanced promotion of user participation, and progressive optimization of language-related guidance while efficiently using processing and communication resources.

The term “processor” refers to a data processing unit, such as a central processing unit or other computing circuitry, that executes instructions to perform logical, arithmetic, control, and data transfer operations.

The term “system” refers to a combination of hardware and software components, including at least a processor, a memory, a communication interface, and one or more user terminals, that cooperate to perform discussion support processing.

The term “external information source” refers to any data provider or storage from which the system acquires information, such as a database, a file storage, a network service, or an information feed.

The term “information” refers to data items, including text, metadata, numerical values, or structured records, that can be processed by the processor to extract concepts or topics.

The term “concept” refers to an abstract idea or notion derived from the information, such as a subject, category, or key term that represents a main content element.

The term “topic” refers to a principal subject or theme of a discussion or document that is identified by analyzing the information.

The term “generative AI model” refers to a trained machine learning model, such as a probabilistic or neural network-based language model, that generates text outputs in response to input data, including prompt sentences.

The term “prompt sentence” refers to a text input provided to the generative AI model that specifies instructions, context, constraints, or examples to guide generation of an output text.

The term “instruction information” refers to data including at least one prompt sentence and related control parameters that direct the behavior of the generative AI model or the discussion support processing.

The term “communication device” refers to hardware and software components that provide data transmission capabilities between the server and user terminals, such as network interface controllers and communication protocols.

The term “user terminal” refers to an end-user computing device, such as a personal computer, a mobile device, or a tablet, that communicates with the system to send and receive discussion-related data.

The term “voice data” refers to digital audio signals representing spoken utterances captured by a user terminal and transmitted to the system.

The term “text data” refers to character-based data, including transcribed speech or directly input text, that represents linguistic content of user utterances.

The term “convert the voice data into text data” refers to processing in which audio signals are subjected to speech recognition to produce corresponding textual representations.

The term “natural language processing” refers to computational techniques for analyzing, interpreting, and transforming text data, including tokenization, parsing, part-of-speech tagging, semantic analysis, and related operations.

The term “utterance” refers to a unit of spoken or written expression by a user in the context of a discussion, including one or more sentences or phrases.

The term “discussion progress state” refers to an evaluation result representing how actively and evenly a discussion is proceeding, based on temporal and quantitative characteristics of utterances.

The term “time information of the utterances” refers to temporal data associated with utterances, including timestamps, time intervals between utterances, and durations of utterances.

The term “number of utterances” refers to a count of utterance units within a specified time period or discussion segment.

The term “speaking ratio for each speaker” refers to a proportion or share of utterances, or of speaking time, attributable to each user relative to other participants.

The term “predetermined condition” refers to at least one threshold or rule, such as a minimum activity level or maximum inter-utterance interval, used to determine whether the discussion progress state should trigger a generative intervention.

The term “context-rich prompt sentence” refers to a prompt sentence that includes a discussion topic, recent utterance content, and at least one discussion progress metric as context for the generative AI model.

The term “recent utterance content” refers to a subset of text data corresponding to the most recent utterances in the discussion, optionally summarized or formatted for inclusion in a prompt sentence.

The term “evaluation result of the discussion progress state” refers to structured data indicating the outcome of analyzing the discussion progress state, such as active, stagnant, or unbalanced participation.

The term “question sentence” refers to a generated text in interrogative form intended to solicit responses from users in the discussion.

The term “activation message” refers to a generated text, including but not limited to a question sentence, that is designed to prompt or encourage additional user utterances.

The term “discussion screen” refers to a user interface displayed on a user terminal that presents discussion content, including utterances, questions, and messages.

The term “grammatical correctness” refers to conformity of text data to grammatical rules of a target language, including syntax and morphology.

The term “semantic clarity” refers to the degree to which the meaning of text data is clear, specific, and understandable to a reader or listener.

The term “logical consistency” refers to the degree to which text data exhibits coherent reasoning, absence of contradictions, and a structured argumentative flow.

The term “feedback information” refers to data generated for a user that includes evaluations, improvement points, and examples of favorable expressions regarding the user's utterances.

The term “improvement points” refers to specific indications of aspects of a user's language use or reasoning that can be enhanced, such as clarity, structure, or vocabulary choice.

The term “examples of favorable expressions” refers to excerpts of a user's utterances or model-suggested phrases that are evaluated as particularly effective or appropriate and are presented as positive references.

The term “utterance history” refers to a record of past utterances associated with a user, including at least text content and time-related information, stored for analysis and adaptation.

The term “generation conditions” refers to parameters and constraints used when constructing prompt sentences and controlling outputs of the generative AI model, such as content focus, number of questions, difficulty level, and personalization settings.

The term “per-user basis” refers to processing performed individually for each user, such that different users may receive different prompt sentences, question sentences, or feedback in response to their respective histories and evaluations.

In one embodiment, a server executes a discussion support program on general-purpose computing hardware. The server includes at least one processor, a main memory, a non-volatile storage device, and a network interface. The processor is, for example, a multi-core central processing unit. The main memory stores program instructions and runtime data structures. The non-volatile storage device stores configuration data, discussion logs, and trained model parameters. The network interface connects the server to multiple terminals via a packet-based communication network.

The server executes operating system software and middleware for network communication.

The server uses a database management system to store structured data such as user profiles, discussion room records, utterance histories, and feedback records. The server executes an application program that implements the functions described in the claims and controls data flows between modules. The server interacts with at least one generative AI model that is implemented as a trained neural network. The generative AI model is, for example, a transformer-based language model that has multiple self-attention layers, feed-forward layers, layer normalization, and learned token embeddings.

The server stores, in the storage device, configuration data for the generative AI model, including a model identifier, vocabulary size, number of layers, hidden dimension, number of attention heads, and activation functions. The server also stores training-related metadata such as the type of loss function used to train the model, for example, a cross-entropy loss over predicted next tokens, and the optimization algorithm, for example, a gradient-based algorithm with adaptive learning rates. The server does not perform full training of the generative AI model in the deployed environment in this embodiment, but the server may perform fine-tuning or parameter-efficient adaptation by loading adapter parameters or prompt-tuning vectors into memory and combining them with base model parameters.

The server stores multiple prompt templates in the storage device. Each template is a text pattern with placeholders for a discussion topic, recent utterance content, and discussion metrics. The server combines these templates with runtime data to construct a concrete prompt sentence to be supplied to the generative AI model. For example, the server may store and later use the following prompt sentence:
“You are a facilitator in an online discussion room. The topic is: ‘Remote work productivity’. The discussion has slowed down. Recent utterances are: [summary of recent discussion]. Please generate three open-ended questions that (1) encourage quiet participants to speak, (2) relate directly to the recent utterances, and (3) can be answered in one or two minutes.”
   The server may also store evaluation-oriented prompt sentences such as:
“You are evaluating a participant's language in an online discussion about ‘Remote work productivity’. Here are several of this participant's statements: [list of utterances]. Please evaluate (1) grammatical correctness, (2) clarity, and (3) logical coherence. Then provide three concrete suggestions for improvement, and highlight one particularly good expression and explain why it works well.”

The server uses a natural language processing library to perform deterministic preprocessing and analysis of text data. The server tokenizes text, assigns part-of-speech tags, and constructs syntactic dependencies. The server further extracts named entities, key phrases, and sentence boundaries. The server represents each utterance as a structured object that includes fields for user identifier, discussion room identifier, timestamp, raw text, token sequence, syntactic annotations, and semantic annotations. The server stores these objects in the database so that subsequent modules can access them.

The terminal is a computing device such as a smartphone, tablet, or personal computer. The terminal executes a client application or a browser-based interface that communicates with the server. The terminal includes a microphone, a display, and input devices. The terminal captures user's voice through the microphone using an audio acquisition driver and sends digitized audio signals to the server. The terminal captures typed text input from the user and sends the text through network requests to the server. The terminal receives question sentences, activation messages, and feedback information from the server and displays them in a discussion interface.

The user operates the terminal to participate in a discussion session. The user speaks into the microphone or types messages. The user reads questions and feedback presented on the display. The user is not required to understand internal processing; all computation is performed by the server and the terminal according to the program.

The server uses an automatic speech recognition engine to transform voice data into text data.

The server supplies audio frames from the terminal to the speech recognition engine. The engine applies signal processing (for example, feature extraction with Mel-frequency cepstral coefficients) and a sequence model (for example, a neural network with convolutional and recurrent layers) to output text tokens. The server collects partial recognition results, merges them, and associates them with a particular utterance object in the database. This conversion from voice data to text data enables the server to apply the same natural language processing pipeline to both spoken and typed input.

The server computes multiple discussion progress metrics from the utterance objects. The server calculates, for each utterance, a time interval from the previous utterance in the same discussion room. The server maintains a sliding time window and counts utterances within that window, grouped by user. The server computes a speaking ratio for each user as the number of utterances or the cumulative length of utterances for the user divided by the total for all users in the window. The server stores these metrics as numeric values in memory and, optionally, as records in the database.

The server compares the numeric metrics against threshold values and rules that are configured as part of the discussion support program. For example, the server may determine that the discussion is stagnant when an average inter-utterance interval exceeds a predetermined number of seconds or when the total number of utterances in the last minute is below a predetermined number. The server may determine that a specific user is under-participating when the user's speaking ratio falls below a minimum percentage. The server represents the evaluation result of the discussion progress state as a structured record that includes an activity level label and associated numeric values.

The server then constructs a context-rich prompt sentence by filling a template with the discussion topic, recent utterance content, and the evaluation result. The server retrieves several recent utterances from the database, generates a condensed textual summary, and inserts that summary into the prompt sentence. The server includes the activity level label and key metric values in natural language form within the prompt sentence. This explicit inclusion of machine-computed metrics as text distinguishes the processing from simple transcription or summarization; the generative AI model receives quantitative feedback about the discussion, which influences the generation of appropriate questions.

The server supplies the constructed prompt sentence to the generative AI model. In one embodiment, the generative AI model is deployed as a service that the server accesses via a local procedure call or network API. The server formats the prompt and additional generation parameters such as maximum output length, randomness degree, and number of candidate outputs. The generative AI model processes the prompt using its neural network architecture.

The model represents the prompt sentence as a sequence of tokens and computes multi-head self-attention at each transformer layer. The model generates one token at a time by computing a probability distribution over the vocabulary and selecting a token based on the distribution and the specified randomness degree. The server receives the generated tokens and concatenates them into a question sentence or activation message.

The server implements post-processing rules that are independent of human behavior. The server splits the generated text into multiple candidate question sentences, checks each sentence for length bounds and presence of required keywords, and discards sentences that do not satisfy predefined conditions. The server may compute an embedding for each candidate question and compare it to embeddings of recently used questions to avoid repetition. The server selects a final set of question sentences based on these objective criteria. Because the server uses algorithmic filters and vector comparisons at the machine level, the selection process is not a mere human preference emulation but an engineered procedure that improves diversity and relevance of generated questions.

The server sends the selected question sentences or activation messages to all terminals associated with the discussion room. The server uses persistent communication channels to push data in real time. The terminal receives the messages, updates its internal state, and renders the texts in a dedicated region of the discussion interface. The terminal may visually emphasize these messages and optionally trigger audio signals to draw user attention. The technical effect of this process is that the client devices render machine-generated activation content at appropriate times, reducing idle network traffic because the server only transmits questions when the computed progress state meets activation conditions.

The server also uses the generative AI model to generate linguistic feedback. The server groups utterances by user and selects representative segments. The server constructs an evaluation prompt sentence by inserting user-specific utterances into a template that requests evaluation of grammatical correctness, semantic clarity, and logical consistency, and requests concrete suggestions. The server then calls the generative AI model with this evaluation prompt sentence. The generative AI model computes an analysis output that includes descriptive feedback. The server does not accept this feedback blindly; the server applies deterministic checks to ensure that the output conforms to expected structure, such as presence of separate sections for grammar, clarity, logic, and suggestions.

The server creates feedback records that associate each user with the received feedback text and with specific utterance identifiers. The server stores these records in the database. The server also extracts meta-information from the feedback, such as which linguistic properties were evaluated as weak or strong. The server encodes these properties as numeric or categorical indicators. For example, the server may convert a qualitative statement about ambiguity into a numeric clarity score. The server incorporates these indicators into generation conditions for future prompt sentences and question sentences.

The server applies a non-human heuristic to adjust future prompts based on feedback indicators. When the server constructs a new prompt sentence for the same user, the server modifies the prompt template by injecting explicit instructions that target the user's weaknesses or strengths. For instance, if a user frequently uses vague terms, the server adds text to the prompt such as “encourage the user to provide concrete examples and avoid vague expressions.” The server also adjusts numeric generation parameters, such as requesting more examples or more detailed reasoning from the generative AI model. These modifications are executed according to a rule-based engine that operates on feedback indicators, utterance history, and time since last feedback, thereby implementing a control policy that is not equivalent to manual human editing.

The server thereby realizes a technical improvement in computer operation. Because the discussion progress state is quantified and used to condition the generative AI model, the server avoids unnecessary model invocations in periods of normal activity, reducing processor load and network usage. When activation is required, the generative AI model receives richer context and structured metrics, which leads to more targeted outputs and reduces the need for repeated or corrective calls. This improves computation efficiency by reducing wasted generations and accelerates response time. Additionally, by storing utterance histories and feedback indicators in optimized data structures, such as indexed tables keyed by user and discussion room, the server can quickly fetch relevant data for prompt construction, further reducing latency.

The server, in another embodiment, executes multiple generative AI models of different sizes or capabilities and selects a model based on the complexity of the task. For example, for simple clarification questions, the server chooses a smaller model with fewer layers and less memory usage; for complex language evaluation, the server chooses a larger model. The selection is based on discussion metadata and feedback history. This dynamic model selection improves computational resource utilization and reduces energy consumption compared to a system that always uses a maximum-capacity model.

The server may additionally implement a hybrid rule-based and model-based generation scheme. The server maintains a library of template questions for standard conditions, such as early in a discussion or when identical stagnation patterns are detected. When the computed metrics match a known pattern, the server uses only a template question without invoking the generative AI model. When the metrics do not match any known pattern, the server constructs a novel prompt sentence and invokes the generative AI model. This hybrid approach further reduces computation and improves responsiveness, representing a non-conventional control flow for discussion support systems.

The terminal may be configured in alternate embodiments. In one variant, the terminal performs preliminary keyword detection from audio using lightweight models and sends both audio and extracted features to the server. This reduces server-side computation for trivial noise segments. In another variant, the terminal caches the most recent question sentences and activation messages so that when the user reconnects, the terminal can display them immediately without waiting for a server re-send.

The user can employ the system in different usage scenarios. In an online seminar, the user as a facilitator configures a topic and invites participants. In a corporate meeting, the user as a participant receives individualized feedback between sessions and adjusts their speaking style. The system operates transparently from the user's perspective but internally applies the described control of generative AI behavior and data processing.

Because the server uses specific data structures, thresholds, and rules to compute discussion progress and apply that state to the control of prompt sentences and generative outputs, the system is not a mere automation of a human moderator. Human moderators do not naturally compute numeric speaking ratios or average inter-utterance intervals across many participants in real time, nor do they dynamically adjust internal neural network parameters and prompt content based on formalized feedback metrics. By contrast, the server performs these operations at high speed, with consistent criteria, and with adaptive interaction rules that are not practical without computer implementation. As a result, the system provides improved technical performance in terms of response latency, relevance of generated messages, balanced network load, and structured long-term adaptation of generative outputs.

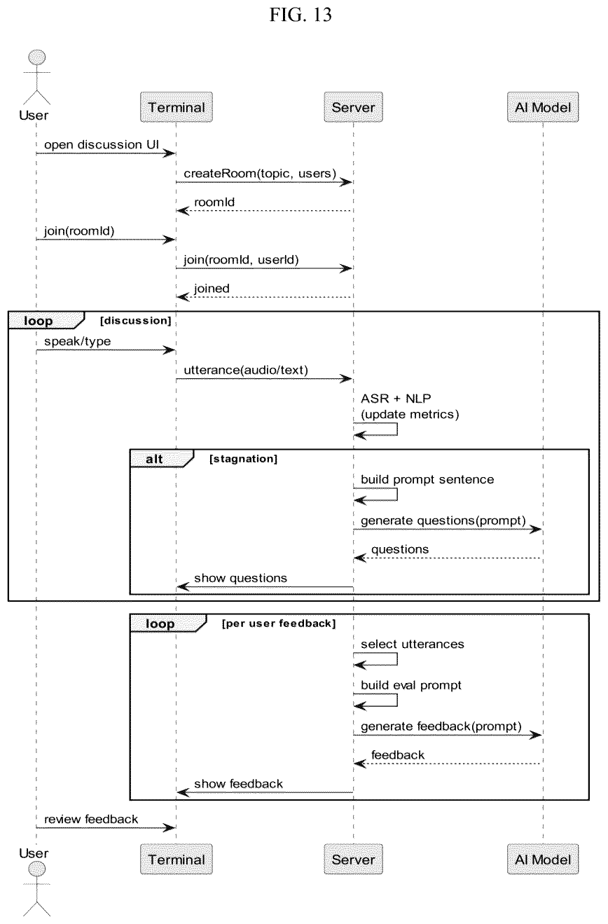

The following describes the processing flow using FIG. 13.

### Step 1:

Server initializes core modules and data structures.

Server loads configuration data from storage, including discussion room settings, model parameters, threshold values for activity metrics, and prompt templates. As input, server uses stored configuration records and program code. Server allocates data structures in memory, such as an utterance history list, a discussion metrics object, and a per-user feedback profile table. Server outputs an initialized runtime environment in which all required modules (speech recognition interface, natural language processing module, generative AI model interface, and database client) are ready for use.

### Step 2:

User creates a discussion room via a terminal.

User operates the terminal to input a discussion topic, a list of participants, and optional settings such as discussion language and duration. As input, terminal uses user keystrokes and UI selections. Terminal packages this information into a structured request and sends it to the server over a network connection. Terminal outputs a room creation request message containing the topic text, participant identifiers, and setting values.

### Step 3:

Server creates and registers the discussion room.

Server receives the room creation request from the terminal. As input, server uses the topic, participant list, and settings contained in the request. Server validates the data, generates a unique room identifier, and stores a room record in a database table. Server then generates invitation tokens or links and associates them with the room identifier. Server outputs a room creation response, including the room identifier and invitation information, and updates internal state so that subsequent utterances can be associated with this room.

### Step 4:

Terminal joins the discussion room and establishes a real-time channel.

User selects the created room or opens an invitation link on the terminal. As input, terminal uses the room identifier and authentication information stored for the user. Terminal sends a join request to the server and opens a real-time communication channel, such as a WebSocket connection, to receive and send discussion data. Terminal outputs an active session state in which the discussion interface is displayed and network channels are established.

### Step 5:

Server activates monitoring for the discussion room.

Server receives the join request and real-time connection from the terminal. As input, server uses the room identifier and user identifier from the connection handshake. Server updates in-memory structures to register the terminal as an active participant and initializes per-participant counters in the discussion metrics object. Server outputs an active monitoring state for the room, enabling the collection and analysis of utterances from all connected terminals.

### Step 6:

User produces an utterance via voice or text.

User speaks into the microphone of the terminal or types a message into a text input field. As input, terminal uses audio signals from the microphone or keystrokes from the input device.

User completes the utterance by pressing a send or stop-speaking control. User outputs raw communication content (voice waveform or text characters) that will be processed by the terminal and the server.

### Step 7:

Terminal captures and transmits utterance data.

Terminal receives audio samples from the microphone or text characters from the UI. For voice input, terminal digitizes the audio and segments it into frames; for text input, terminal collects the typed characters into a complete message. As input, terminal uses the raw waveform or character stream. Terminal attaches metadata such as timestamp, room identifier, and user identifier to the data, and transmits the audio or text payload to the server over the established real-time channel. Terminal outputs an utterance message that encapsulates the user's contribution in a structured format.

### Step 8:

Server converts voice data to text and normalizes all utterances.

Server receives utterance messages from terminals. As input, server uses the transmitted audio frames or plain text messages, along with associated metadata. For audio input, server invokes a speech recognition engine, which computes features from the waveform, applies a sequence model, and outputs a sequence of recognized tokens. Server merges partial recognition results into a final text string. For text input, server directly accepts the text string. Server then normalizes the text by standardizing character encoding, removing control characters, and optionally lowercasing according to language rules. Server outputs a unified utterance record containing text content, user identifier, room identifier, and a timestamp.

### Step 9:

Server performs natural language processing on the utterance.

Server takes the unified utterance record as input. Server uses a natural language processing library to tokenize the text, tag parts of speech, and compute syntactic dependencies. Server may also detect sentences, extract named entities, and identify key phrases. Server stores the resulting annotations in a structured object linked to the utterance record. Server outputs a processed utterance object that includes raw text, token list, grammatical tags, dependency tree, and semantic markers, which will be used in later analysis and prompt construction.

### Step 10:

Server updates discussion metrics based on the new utterance.

Server uses the processed utterance object and the existing metrics object for the corresponding room as input. Server computes the time interval since the previous utterance in the room by subtracting the stored previous timestamp from the current utterance timestamp. Server increments the total utterance count, updates per-user utterance counts, and recalculates speaking ratios for all users within a sliding time window. Server stores the new interval and counts in the metrics object. Server outputs updated numeric metrics, such as average inter-utterance interval, utterances per minute, and per-user speaking ratios.

### Step 11:

Server evaluates the discussion progress state.

Server takes the updated metrics as input. Server compares each metric to predetermined threshold values and applies rule-based logic, such as checking whether the average inter-utterance interval exceeds a maximum value or whether one or more users fall below a minimum speaking ratio. Server classifies the discussion state into categories, for example “active,” “stagnant,” or “unbalanced.” Server records the classification and underlying metric values in a state record. Server outputs a discussion progress state object that will guide subsequent generative AI actions.

### Step 12:

Server decides whether to generate activation questions.

Server uses the discussion progress state object and a record of the last activation time as input. Server evaluates whether the current state satisfies a generation condition, such as the state being “stagnant” and a minimum cooling period having elapsed since the last generated question. If the condition is not met, server outputs a decision to skip generation and waits for further utterances. If the condition is met, server outputs a decision to start activation question generation and proceeds to construct a context for the generative AI model.

### Step 13:

Server compiles recent utterance context for prompt construction.

Server uses the utterance history for the room and the decision to generate activation content as input. Server selects a subset of recent utterances, for example the last ten utterances, and extracts their text content and user identifiers. Server may summarize the text by truncating long utterances or combining related snippets. Server then formats the selected content into a textual block, enclosing each utterance with the speaker label. Server outputs a recent context string that describes what has been discussed immediately before the stagnation.

### Step 14:

Server constructs a context-rich prompt sentence for the generative AI model.

Server uses the discussion topic, the recent context string, and the evaluation result of the discussion progress state as input. Server selects an appropriate prompt template for activation questions and fills its placeholders with these inputs. For example, server may generate a prompt sentence such as:
“You are a facilitator in an online discussion room. The topic is: ‘Remote work productivity’. The discussion has slowed down. Recent utterances are: [recent context]. Please generate three open-ended questions that (1) encourage quiet participants to speak, (2) relate directly to the recent utterances, and (3) can be answered in one or two minutes.”

Server then applies formatting rules, such as removing excess whitespace and ensuring language consistency. Server outputs a complete prompt sentence ready to be submitted to the generative AI model.

### Step 15:

Server invokes the generative AI model to produce candidate questions.

Server takes the constructed prompt sentence and generation parameters (such as maximum length and randomness degree) as input. Server transmits these inputs to the generative AI model through a model interface. The model processes the prompt by encoding it into tokens, computing attention scores across tokens in multiple layers, and iteratively predicting the next token until a termination condition is met. Server receives the sequence of generated tokens from the model and reconstructs them into a text output. Server outputs a raw generated text that typically contains one or more candidate question sentences.

### Step 16:

Server post-processes generated text to select final question sentences.

Server uses the raw generated text as input. Server splits the text into individual sentences using punctuation and linguistic heuristics. For each sentence, server checks constraints such as minimum and maximum length and filters out sentences that do not have interrogative markers or that duplicate earlier questions in the session. Server may compute a similarity score between each candidate and previously used questions by embedding each sentence into a vector space and comparing distances. Server discards candidates that are too similar to past questions and selects remaining candidates as final question sentences. Server outputs a list of validated question sentences for display to the participants.

### Step 17:

Server transmits activation questions to terminals.

Server takes the list of validated question sentences and the active participant list as input.

Server composes a message that includes the room identifier and the selected question sentences, and sends this message via the real-time communication channels to all participant terminals or to a designated subset of terminals. Server logs the sent questions in the utterance history to avoid future duplication. Server outputs a set of outbound messages that carry the activation content to end-user devices.

### Step 18:

Terminal displays the activation questions to the user.

Terminal receives the question message from the server. As input, terminal uses the text of each question, along with the room identifier and timestamps. Terminal updates its internal state for the discussion view and renders the questions in a prominent area of the user interface, such as at the top of the message list or in a highlighted pane. Terminal may trigger visual cues or audio notifications to attract attention. Terminal outputs an updated display showing the activation questions and thereby prompts the user to respond.

### Step 19:

Server periodically evaluates linguistic quality for each user.

Server uses the accumulated processed utterances from a particular user as input. Server selects representative utterances over a defined time period and creates a list of sentences that illustrate the user's speaking style. Server also consults previous feedback records to avoid redundant evaluation. Server outputs a candidate set of user utterances to be passed to the generative AI model for qualitative analysis.

### Step 20:

Server constructs an evaluation-oriented prompt sentence.

Server takes the candidate set of user utterances and the discussion topic as input. Server selects a feedback-oriented template and fills it with the topic and the user utterances. For example, server constructs a prompt sentence such as:
“You are evaluating a participant's language in an online discussion about ‘Remote work productivity’. Here are several of this participant's statements: [list of utterances]. Please evaluate (1) grammatical correctness, (2) clarity, and (3) logical coherence. Then provide three concrete suggestions for improvement, and highlight one particularly good expression and explain why it works well.”

Server cleans the prompt to ensure readability and consistent formatting. Server outputs a complete evaluation prompt sentence.

### Step 21:

Server invokes the generative AI model to obtain feedback text.

Server uses the evaluation prompt sentence and suitable generation parameters as input.

Server sends them to the generative AI model using the same or a similar interface as for question generation. The model processes the prompt and generates a structured feedback text that includes comments on grammar, clarity, logical structure, and suggestions for improvement. Server receives the generated tokens, assembles them into text, and performs basic structural checks to confirm that required sections are present. Server outputs a feedback text string that is associated with a specific user.

### Step 22:

Server stores and structures feedback information.

Server uses the feedback text and the associated user identifier as input. Server creates a feedback record that includes the text, the related utterance identifiers, the time of generation, and derived indicators such as identified weaknesses and strengths. Server parses the feedback text using natural language processing to detect references to specific linguistic properties and encodes these as numeric or categorical values, such as scores for grammatical correctness or clarity. Server stores the feedback record and indicators in the database. Server outputs a persistent feedback entry that can be retrieved in future sessions.

### Step 23:

Server updates generation conditions for future prompt sentences and questions.

Server uses stored feedback indicators, utterance history, and discussion metadata as input.

Server applies rule-based logic to adjust parameters for future prompt construction, such as specifying that upcoming questions should solicit more detailed reasoning from a user with weak logical coherence or should encourage concrete examples from a user with low specificity. Server may update internal tables that map user identifiers to personalized prompt modifiers and generation parameter sets. Server outputs updated generation conditions that will influence how future prompt sentences and question sentences are constructed and how the generative AI model is controlled.

### Step 24:

Terminal receives and presents individualized feedback to the user.

Terminal receives a feedback message from the server, which includes the feedback text and the user identifier. As input, terminal uses this data to determine that the feedback is intended for the current user. Terminal opens or updates a personal feedback panel in the user interface and displays the feedback text with appropriate formatting, such as section headings and bullet points. Terminal allows the user to scroll through the feedback and optionally mark it as reviewed. Terminal outputs an updated user interface state that provides the user with actionable linguistic guidance.

### Step 25:

User reviews feedback and adapts future utterances.

User reads the feedback on the terminal's display. As input, user uses the presented comments, improvement points, and highlighted favorable expressions. User mentally integrates this information and adjusts how future utterances are produced, for example by speaking more clearly, structuring arguments more logically, or choosing more precise vocabulary. User outputs improved utterances in subsequent discussion turns, which the terminal and server capture and process in the same manner as earlier utterances, thereby closing the loop of adaptive discussion support.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented language training and dialogue systems suffer from several technical limitations that reduce both system efficiency and interaction quality.

First, many systems treat speech recognition, language evaluation, and feedback generation as isolated processes, without a unified control flow executed by a processor. As a result, these systems cannot adapt their internal processing, such as prompt generation or dialogue management, based on fine-grained, time-series analysis of user utterances. This leads to static behavior, inefficient use of computational resources, and latency in providing feedback to users.

Second, conventional systems typically generate discussion topics or prompts using fixed templates or manually designed rules. Such approaches do not exploit the full capabilities of generative AI models and do not incorporate dynamically extracted high-level themes from external document information. Consequently, the computer system cannot automatically tailor its prompt sentences to the current content domain, the user's performance history, or the evolving context of an ongoing discussion, which limits the system's ability to maintain user engagement and to guide the interaction effectively.

Third, known language evaluation engines primarily analyze grammatical correctness or simple lexical features. They do not integrate structured measures of logical consistency, fluency, and emotional state into a unified evaluation object for each utterance, nor do they aggregate such evaluation information in time series to form a performance profile per user. Therefore, the processor cannot efficiently compute and update a data structure that captures persistent strengths and weaknesses of each user, and cannot leverage this data structure to optimize future prompt generation and dialogue control decisions. This results in suboptimal personalization and redundant or inappropriate feedback, increasing computational waste and processing time.

Fourth, existing dialogue systems have limited capability to monitor conversation flow at the system level. They often do not measure utterance intervals, detect silence or hesitation patterns, or correlate such patterns with emotion analysis results in real time. Without such low-level monitoring by the processor, the system cannot automatically generate context-appropriate question sentences or topic-presentation sentences using a generative AI model to prevent stagnation or breakdown of the interaction. This leads to longer idle times, inefficient use of communication channels, and decreased throughput of the overall system.

Fifth, many systems handle emotion analysis only as a cosmetic feature and do not feed emotion information back into the core control logic executed by the processor. As a result, the system does not adjust the content or tone of its own utterances (for example, moderator interventions) based on recognized emotional states such as anger, joy, or sadness. This prevents the system from automatically generating adjustment utterance text that calms or activates the discussion in a controlled manner, and thus from stabilizing interaction dynamics at the system level.

Accordingly, there is a need for an improved computer-implemented system in which a processor integrates (i) extraction of high-level theme information and phrase information from external document information, (ii) generation of prompt sentences using a generative AI model, (iii) multi-dimensional evaluation of user utterances including grammar, lexical appropriateness, logic, fluency, and emotion, and (iv) time-series aggregation and use of performance information for adaptive prompt generation and dialogue control. Such a system should technically improve the operation of computers by reducing manual configuration of prompts, minimizing unnecessary model calls and redundant feedback generation, and enabling real-time, context-aware adjustments to dialogue flow and emotional tone based on data structures maintained by the processor.

The specific processing by the specific processing unit 290 of the data processing device 12 in Application Example 2 is realized by the following means.

The present invention provides a server comprising a processor configured to analyze document information acquired from an external information source to extract theme information and phrase information represented as higher-level concepts, to generate, by using a generative AI model, a prompt sentence serving as a discussion subject on the basis of the extracted theme information and phrase information, and to store the prompt sentence as guidance text for a discussion; to convert user audio information into character information by executing speech recognition processing, and to analyze the character information as syntactic information and semantic information by using a natural language processing technique; to generate, on the basis of an analysis result of the character information, evaluation information indicating grammatical accuracy, lexical appropriateness, logical consistency, and fluency of language expressions used in the discussion; to perform emotion analysis processing on the character information so as to identify emotion information indicating emotion types and emotion intensities, and to associate the emotion information with the evaluation information; to construct, on the basis of input information including the analysis result containing the evaluation information and the emotion information, a prompt sentence for the generative AI model, and to automatically generate feedback text for each user by using the generative AI model with the constructed prompt sentence; to aggregate the evaluation information and the emotion information in time series to generate performance information indicating characteristics of language ability and emotional expression for each user; to generate, on the basis of the performance information, a new prompt sentence adapted to weaknesses and strengths of each user for subsequent discussions, and to generate the new prompt sentence as utterance text for dialogue control that controls progress of the discussion; to monitor intervals and lengths of utterances during progress of the discussion, to detect a silent state or a hesitating state, and, on the basis of a detection result and the emotion information, to generate, by using the generative AI model, a question sentence or a topic-presentation sentence that activates the discussion; and to transmit the generated feedback text, the question sentence, and the topic-presentation sentence to a terminal device and cause the terminal device to perform display output or audio output of the feedback text, the question sentence, and the topic-presentation sentence. This enables the computer system to automatically and adaptively manage discussion content and flow by using integrated, time-series evaluation and emotion information, to personalize prompt sentences and moderator interventions in real time based on structured performance profiles, and to reduce manual configuration and inefficient processing, thereby improving the technical functioning, responsiveness, and resource utilization of the underlying computing infrastructure.

The term “document information” refers to text data and associated metadata obtained from an external information source, including but not limited to articles, reports, messages, and other linguistically structured content to be analyzed by the processor.

The term “external information source” refers to any information-providing system or storage, such as a network-accessible service, database, or content repository, from which the server acquires document information.

The term “theme information” refers to data representing higher-level topics or subjects abstracted from document information, such as overarching issues, discussion themes, or conceptual categories identified by the processor.

The term “phrase information” refers to data representing linguistic segments, such as words, word groups, or expressions, extracted from document information and related to the theme information.

The term “higher-level concepts” refers to abstractions derived from specific terms or phrases, such as generalized topics, categories, or semantic groupings, which characterize the content of document information at a more conceptual level.

The term “generative AI model” refers to a machine-implemented model that generates text or other data outputs in response to input data and instructions, based on parameters learned from training data, and that is configured to produce prompt sentences, feedback text, or other utterance text.

The term “prompt sentence” refers to a text string provided as an instruction or input to a generative AI model, the text string specifying a task, context, or format that guides the generation of output data such as discussion questions or feedback.

The term “guidance text” refers to a prompt sentence or similar text used to present, introduce, or direct a discussion topic or activity to a user.

The term “user audio information” refers to audio signals representing speech uttered by a user and captured by an audio acquisition device for processing by the processor.

The term “character information” refers to text data obtained by converting user audio information through speech recognition processing, including sequences of characters or tokens representing the recognized speech.

The term “speech recognition processing” refers to computer-implemented processing that receives audio signals and outputs corresponding character information by applying acoustic modeling, linguistic modeling, and decoding algorithms.

The term “natural language processing technique” refers to a computer-implemented technique that analyzes character information to determine linguistic structures and meanings, including but not limited to tokenization, part-of-speech tagging, syntactic parsing, semantic analysis, and discourse analysis.

The term “syntactic information” refers to data describing structural relationships among linguistic units in character information, such as parts of speech, phrase structures, or dependency relations.

The term “semantic information” refers to data describing meanings associated with linguistic units in character information, such as sense, roles, or relations between entities and concepts.

The term “evaluation information” refers to data generated by the processor that quantitatively or qualitatively indicates performance or quality of language expressions, including measures of grammatical accuracy, lexical appropriateness, logical consistency, and fluency.

The term “grammatical accuracy” refers to a degree to which language expressions conform to grammatical rules of a target language, such as correct use of tense, agreement, word order, and function words.

The term “lexical appropriateness” refers to a degree to which selected words and phrases are suitable and natural for a given context, topic, and proficiency level in the target language.

The term “logical consistency” refers to a degree to which language expressions exhibit coherent reasoning, lack of contradiction, and clear connections between premises and conclusions.

The term “fluency” refers to a degree to which utterances are produced smoothly and naturally, considering factors such as sentence length, connectedness, hesitations, and overall flow.

The term “emotion analysis processing” refers to computer-implemented processing that analyzes character information to identify emotional attributes such as emotion types and emotion intensities.

The term “emotion information” refers to data indicating emotional characteristics of an utterance, including emotion types such as anger, joy, or sadness, and corresponding emotion intensities or confidence values.

The term “analysis result” refers to output data of one or more processing stages, including natural language processing and emotion analysis, the output data comprising syntactic information, semantic information, evaluation information, and emotion information.

The term “feedback text” refers to text generated by the processor that provides comments, evaluations, corrections, or suggestions to a user regarding the user's language expressions or emotional expression.

The term “time series” refers to an ordered sequence of data points associated with temporal positions, used to represent evaluation information and emotion information across multiple utterances over time.

The term “performance information” refers to data derived from time-series aggregation of evaluation information and emotion information, the data indicating long-term characteristics of a user's language ability and emotional expression.

The term “weaknesses and strengths” refers to aspects of a user's language ability and emotional expression that are respectively lower-performing or higher-performing when evaluated across multiple utterances and sessions.

The term “new prompt sentence” refers to a prompt sentence generated after evaluation and aggregation processes, the prompt sentence being adapted to identified weaknesses and strengths of a user for use in subsequent discussions.

The term “utterance text for dialogue control” refers to text used by the system to manage or steer a discussion, including moderator-like utterances that introduce topics, ask questions, or guide turn-taking.

The term “dialogue control” refers to computer-implemented control over the progress of a discussion, including management of topics, timing, participant engagement, and intervention utterances.

The term “utterance interval” refers to a time period measured between an end of one utterance and a start of another utterance within a discussion.

The term “utterance length” refers to a measure of temporal duration or textual size of an utterance, such as spoken time or number of words.

The term “silent state” refers to a condition detected by the processor in which no utterance is produced for at least a predetermined time threshold during a discussion.

The term “hesitating state” refers to a condition detected by the processor in which patterns such as prolonged pauses, fillers, or repeated restarts indicate hesitation by a user.

The term “question sentence” refers to text generated by the processor and configured to solicit a response or opinion from a participant in a discussion.

The term “topic-presentation sentence” refers to text generated by the processor and configured to introduce or shift to a specific subject or theme within a discussion.

The term “terminal device” refers to a user-end device capable of communicating with the server, including but not limited to a mobile device, a wearable device, or a computing device, and configured to display or output text or audio.

The term “display output” refers to visual presentation of information on a visual interface of a terminal device, such as a screen or projection surface.

The term “audio output” refers to reproduction of sound, such as synthesized speech or alerts, through an audio transducer of a terminal device.

The term “storage region” refers to a logical or physical area of memory or storage medium accessible by the processor and used to store data such as feedback text, performance information, and prompt sentences.

The term “storage result” refers to a state or content of data stored in the storage region after writing or updating operations performed by the processor.

The term “proficiency level” refers to an estimated degree of a user's skill in a target language, determined on the basis of evaluation information aggregated over time.

The term “interest” refers to a preference or tendency of a user toward particular topics, styles, or activities, inferred from interaction history, performance information, or explicit input.

The term “emotional state” refers to a current or recent emotional condition associated with a user, represented by emotion information including at least one emotion type and intensity.

The term “predetermined condition” refers to a rule or threshold defined in advance and used by the processor to determine whether an emotional state or other parameter warrants a particular processing action.

The term “adjustment utterance text” refers to text generated by the processor for moderating emotional tone, the text being configured to calm or stimulate the emotional state of participants in a discussion.

The term “intervention utterance text” refers to adjustment utterance text that is output as if spoken by a moderator or system agent to intervene in an ongoing discussion.

The term “moderator of the discussion” refers to a logical role implemented by the system or a human participant that manages progression of the discussion, including turn-taking, topic selection, and conflict mitigation.

In one embodiment, a server, a terminal, and a user cooperate to implement the invention. The server is implemented by one or more computing devices each comprising a central processing unit (CPU), a main memory, a non-volatile storage device, a network interface, and optionally a graphics processing unit (GPU) for accelerating neural network computations. The terminal is implemented by a user device such as a smartphone, a tablet computer, a wearable device, or a personal computer, each comprising a processor, a memory, a display, an audio input device such as a microphone, and an audio output device such as a speaker or earphone. The server and the terminal communicate through a communication network such as the Internet using standard communication protocols.

The server stores program modules and data structures in a storage device such as a magnetic disk, a solid-state drive, or network-attached storage. The server loads these modules into memory and executes them on the CPU and, where applicable, on the GPU. The server stores a generative AI model in a model repository. The generative AI model is, for example, a transformer-based neural network pre-trained on large-scale text data and optionally fine-tuned on data specific to discussion, feedback, and instructional prompts. The server also stores parameters and configuration files that define the structure of the neural network, including a number of layers, a number of attention heads, embedding dimensions, positional encoding methods, activation functions, and optimization hyperparameters.

The server stores document information obtained from one or more external information sources, such as news feeds, document databases, or web content repositories. The server normalizes the document information by representing each document as a record in a database. Each record includes fields for document identifier, source identifier, title text, body text, metadata such as publication time, and additional features such as language code and category. The server uses a relational database or a key-value store to maintain these records, and indexes the text fields using full-text search indexes to enable efficient retrieval.

The server uses software modules for text processing, including a natural language processing library such as a syntactic parser, a tokenizer, and a named entity recognizer. The server applies these modules to the body text of each stored document to derive theme information and phrase information. The server represents theme information as vector embeddings computed by a sentence embedding model or a topic model such as a neural topic model. The server computes phrase information by extracting noun phrases, verb phrases, and named entities, and encodes these phrases as token IDs, lemma forms, and part-of-speech tags. The server stores the theme information and phrase information in a separate table linked to the document records.

The server uses a clustering algorithm, such as k-means or hierarchical clustering, applied to the theme embeddings to group documents into topics. The server assigns a representative label to each cluster by selecting central phrases or by computing a short textual description using the generative AI model with a dedicated prompt sentence. For example, the server constructs the following prompt sentence for the generative AI model:
“Given the following key phrases: ‘remote work’, ‘mental health’, ‘work-life balance’, ‘isolation’, summarize the main discussion topic in less than 15 words.”

The generative AI model outputs a short phrase such as “Impact of remote work on mental health and work-life balance,” and the server stores this phrase as theme information for that cluster. By representing theme information and phrase information in vector and symbolic forms, the server enables efficient retrieval and reuse of topics for future sessions.

The server uses the generative AI model to generate prompt sentences that serve as discussion subjects or moderator utterances. The server constructs a prompt sentence that includes a theme label, a description of a target language level, and output constraints. For example, the server creates the following prompt sentence:
“The following topic is for an English discussion class: ‘Remote work and mental health.’ Generate five clear English discussion questions for intermediate learners. Each question should invite detailed opinions. Output only the questions as a numbered list.”

The server applies tokenization to this prompt sentence and feeds the resulting tokens to the generative AI model as input. The generative AI model uses a self-attention mechanism to compute contextual representations of each token, and successively predicts output tokens according to a probability distribution defined by the model parameters. The server decodes the output using a decoding algorithm such as beam search with a specified beam width and maximum sequence length. The server then post-processes the generated text by removing repeated questions, normalizing punctuation, and truncating overly long questions. The server stores the finalized prompt sentences linked to theme information in a prompt table.

The terminal retrieves available themes and associated prompt sentences from the server using an application layer interface such as a REST API. The terminal receives structured data describing each theme and prompt sentence and renders them as graphical elements on the terminal display. The user selects a theme and a prompt sentence via a graphical user interface component such as a list or a button. The terminal sends the selection result back to the server, which updates a session record in the database to indicate the current theme and prompt sentence used in that session.

The terminal uses hardware and software components to capture user audio information. The terminal activates an audio input path from the microphone to the processor and samples the analog signal at a defined sampling rate, such as 16 kHz, converting it into digital PCM data with a specified bit depth. The terminal segments the PCM data into frames and packets suitable for transmission to a speech recognition service. The terminal may invoke a cloud-based or local speech recognition engine via an API, providing language codes, acoustic model parameters, and recognition options such as streaming mode or batch mode.

The terminal receives character information as recognition results from the speech recognition engine. The recognition results include recognized text, word-level time stamps, and confidence values. The terminal creates an utterance object containing the recognized text, start time, end time, and speaker identifier. The terminal displays the recognized text on the screen as a real-time transcript. The terminal sends the utterance object to the server via a communication protocol such as HTTPS.

The server receives the utterance object and stores it into an utterance log table. The server applies a natural language processing technique such as tokenization, part-of-speech tagging, and syntactic parsing to the character information. The server constructs a dependency tree representation of the utterance, such as a tree data structure in which each word node has pointers to its head and dependents. The server computes features for evaluation, including counts of grammatical errors, diversity of parts of speech, frequency of cohesive devices, and structural depth of the dependency tree.

The server implements a set of rule-based detectors and machine-learned classifiers to evaluate grammatical accuracy and lexical appropriateness. For example, the server checks for missing auxiliary verbs, incorrect verb tense sequences, article omissions, and subject-verb agreement errors by applying pattern rules to the dependency tree. In addition, the server uses a trained sequence labeling model or a classifier that receives token embeddings and predicts error tags. The server converts the number and severity of detected errors into scores.

The server computes a type-token ratio and compares the vocabulary used to a frequency list appropriate for the user's proficiency level, thereby determining lexical appropriateness.

The server evaluates logical consistency by analyzing discourse markers and sentence structure. The server identifies conjunctions and adverbs such as “however”, “therefore”, and “on the other hand,” and checks whether these markers connect clauses in a way consistent with typical discourse patterns. The server may use a supervised model that takes as input sentence embeddings and outputs a coherence score. The server aggregates these measures to compute evaluation information represented as a record that includes numerical scores and annotations such as a list of error spans and highlighted good expressions.

The server performs emotion analysis processing on the character information. The server converts the utterance into a fixed-length vector representation by applying a text embedding model such as a transformer encoder. The server inputs this vector into an emotion classifier neural network, which may be a multi-layer perceptron or a small transformer, that has been trained to output probabilities for a set of emotion types such as anger, joy, sadness, and neutral. The server multiplies probabilities by predetermined intensity scales to derive emotion intensities. The server stores emotion information as part of the utterance record.

The server combines evaluation information and emotion information into an analysis result object. The server uses this object as part of input information for constructing further prompt sentences for the generative AI model. When the server generates feedback text, the server embeds the original utterance, the evaluation scores, detected errors, and the emotion labels into a prompt sentence. For example, the server constructs the following prompt sentence:
“Analyze the following learner's English statement and provide constructive feedback. Statement: ‘I think the meeting was good, but I not sure about the details.’ Detected issues: —Grammar: missing auxiliary verb in ‘I not sure.’ Scores: grammar 60/100, vocabulary 80/100, logic 75/100. Emotion: neutral, appropriate for a meeting review. Task: 1) Give a short overall comment (1-2 sentences). 2) List ‘Good points’ as bullet points. 3) List ‘Points to improve’ as bullet points with corrected example sentences. Write your answer in simple English, suitable for a B1 learner.”

The generative AI model receives this prompt sentence and generates feedback text. The generative AI model processes the input tokens using its multi-head attention layers, which compute attention weights between tokens based on learned query, key, and value matrices.

The model then applies feed-forward layers with non-linear activations and residual connections to compute output logits over a vocabulary. The server decodes the logits using a decoding strategy such as greedy decoding or top-k sampling, generating a feedback text that follows the instructions embedded in the prompt sentence. The server stores the feedback text and links it to the corresponding utterance and user.

The terminal retrieves the feedback text associated with the current utterance from the server.

The terminal displays the feedback text adjacent to the transcript, and may visually distinguish good expressions and error corrections using color or formatting. The terminal may also invoke a text-to-speech engine to read the corrected sentences aloud, thereby enabling the user to perceive corrected pronunciations.

The server aggregates evaluation information and emotion information for each user across multiple utterances and multiple sessions. The server maintains a performance information record per user, which includes rolling averages and trend data for grammar scores, lexical scores, logical consistency, fluency, and emotion appropriateness. The server optionally applies exponential moving averages or weighted averaging to emphasize more recent data.

The server also identifies recurring error patterns by counting occurrences of specific error types per user.

The server uses the performance information to generate new prompt sentences adapted to each user's weaknesses and strengths. For example, if the server determines that a user makes frequent errors with past tense, the server constructs the following prompt sentence for the generative AI model:
“Based on the learner profile: frequent errors with past tense, good vocabulary, moderate coherence, generate three English discussion prompts that encourage the learner to talk about past experiences and events. Each prompt should require the use of past tense. Output the prompts as a numbered list.”

The generative AI model outputs three practice prompts such as “Talk about a memorable trip you took in the past and what you learned from it.” The server sends these prompt sentences to the terminal, which displays them as practice tasks for the user.

The server monitors conversation flow during discussion sessions by measuring utterance intervals and utterance lengths. The server maintains timestamps for the last utterance from each participant and calculates the time elapsed since the last utterance. If the time exceeds a threshold indicating a silent state, or if transcripts contain repeated fillers and aborted phrases indicating a hesitating state, the server generates a new prompt sentence for the generative AI model with a goal of reactivating the discussion. For example, the server constructs the following prompt sentence:
“Context: English discussion about ‘Remote work and mental health.’ Recent turns: —Participant A: ‘I think remote work is good because I can stay at home, but sometimes I feel lonely.’—Participant B: [silent for 15 seconds] Goal: Encourage Participant B to share their own opinion in a friendly way. Task: Generate one short English question that directly invites B to speak, using simple vocabulary and a polite tone.”

The generative AI model generates a question sentence such as “B, how has remote work affected your feelings and daily life?” The server sends this question sentence to the terminal.

The terminal displays the suggestion as an assistant message, enabling the user or a moderator to speak that sentence and thus resume the discussion.

The server uses emotion analysis results not only for feedback but also for control of the discussion. When the server detects an emotional state meeting a predetermined condition, such as strong anger or high sadness, the server constructs a prompt sentence designed to obtain adjustment utterance text from the generative AI model. For example, the server creates the following prompt sentence:
“A participant has expressed strong anger about government policy in an English discussion. Generate a short, calm moderator message in English that acknowledges their feelings and redirects the discussion to constructive solutions.”

The generative AI model outputs a message such as “I understand that this issue makes you feel very frustrated. Let us think together about what practical steps could be taken to improve the situation.” The server provides this intervention utterance text to the terminal.

The terminal outputs it as moderator speech or displays it for the moderator to read. This architecture enables the server to stabilize discussion dynamics based on quantifiable emotion information rather than static rules.

The disclosed configuration improves computer technology in several ways. Because the server uses structured theme information, phrase information, evaluation information, and performance information in defined data structures, the server can avoid repetitive or redundant calls to the generative AI model. By conditioning prompt sentences on concise, pre-processed features rather than raw transcripts or entire histories, the server reduces input length to the model, lowering computational complexity, inference time, and communication payload size. The server further improves processing speed by applying rule-based filters and lightweight classifiers to screen out trivial utterances that do not require full feedback generation.

The server improves accuracy and robustness of evaluation by combining rule-based grammar checks with machine-learned models and by integrating emotion information into evaluation decisions. This hybrid strategy allows the server to detect errors and emotional cues that are difficult to handle by human-crafted rules alone, and also to reduce false positives through statistical models that have been trained to recognize well-formed constructions and typical emotional expressions. As a result, the server outputs evaluation information and feedback that are more consistent and informative than evaluations performed manually or by narrow-purpose tools.

The server implements a training process for the generative AI model and the emotion classifier. The server uses training data pairs consisting of input text and target output text for tasks such as question generation and feedback phrasing. The server defines an objective function such as cross-entropy loss over the predicted token distributions and uses a gradient-based optimizer such as an adaptive learning rate optimizer to update model weights. The server may perform data augmentation by paraphrasing questions and feedback using back-translation or synonym substitution so that the model generalizes better to unseen inputs. By tuning model parameters to these specific tasks, the server ensures that the model's internal representations capture features relevant to discussion management and feedback.

The server reduces communication load between the server and the terminal by transmitting compact identifiers and references instead of full texts when possible. For example, the server may transmit references to feedback templates and allow the terminal to locally assemble display layouts. The server may also compress text messages using text compression algorithms before transmission, and batch multiple feedback messages into a single network request.

In an alternative embodiment, the server executes the generative AI model locally rather than invoking an external service. The server loads model weights from a storage device into GPU memory and runs inference using a parallelized computation graph. This configuration allows tighter control over latency, memory usage, and scheduling of inference tasks. The server may also adapt model configurations such as maximum sequence length and beam width dynamically based on current server load, balancing response speed and generation quality.

In another embodiment, the terminal performs some natural language processing locally. The terminal may implement a lightweight emotion detection module that operates on device to filter out neutral utterances, sending only emotionally significant or linguistically complex utterances to the server for full analysis. This division of labor reduces load on the server and decreases round-trip time for simple interactions, thereby improving responsiveness of the system from the user's perspective.

The user interacts with the system by selecting topics, speaking into the microphone, and reading or listening to feedback and moderator suggestions. The user may use the system in various environments, such as language learning classrooms, online debate platforms, or customer service contexts in physical stores. In each case, the system uses the described technical mechanisms—structured data representations, composite evaluation algorithms, and context-aware prompt sentences for the generative AI model—to manage discussion content and flow in a way that cannot be replicated by mere human automation of fixed scripts.

Various modifications can be made without departing from the scope of the invention. The server may use different neural network architectures such as recurrent networks or convolutional networks instead of transformer networks. The emotion analysis processing may be integrated into a multi-task model that jointly predicts emotion and quality scores.

The evaluation information and performance information may be stored in different database schemas or formats such as graph databases or document stores. The generative AI model may be replaced by any generative model capable of text generation based on prompt sentences, including models specialized for question generation or feedback generation. The terminal may be any device capable of audio capture and text display. Through these and other variations, the system remains characterized by the combination of extracting higher-level concepts from document information, generating and adapting prompt sentences using a generative AI model, performing integrated evaluation and emotion analysis of user utterances, aggregating performance over time, and using these data structures for real-time dialogue control and feedback generation.

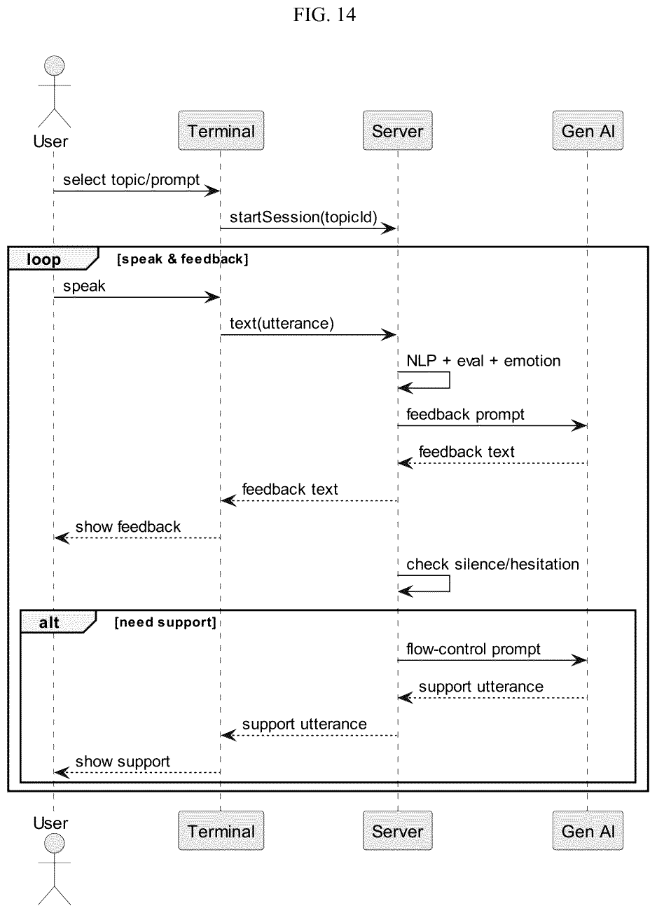

The following describes the processing flow using FIG. 14.

### Step 1:

The server acquires document information from an external information source.

Input: raw data from an external information source (for example, HTTP responses containing markup or structured data).

Output: normalized document records stored in a storage device.

The server sends network requests through a network interface, receives responses, and parses the responses to extract title text, body text, and metadata such as publication time.

The server removes markup, scripts, and non-text elements, converts character encodings, and stores the cleaned text and metadata in a database as document records with unique identifiers.

### Step 2:

The server analyzes each stored document to extract theme information and phrase information.

Input: document records containing title text, body text, and metadata.

Output: theme information and phrase information associated with each document.

The server loads the body text of each document into memory and applies a natural language processing technique such as tokenization and part-of-speech tagging. The server identifies noun phrases, verb phrases, and named entities, and encodes these as phrase information. The server computes vector embeddings of sentences or paragraphs and applies a clustering or topic modeling algorithm to derive higher-level topics, which the server stores as theme information linked to the corresponding documents.

### Step 3:

The server generates base prompt sentences for discussion topics by using a generative AI model.

Input: theme information and phrase information representing abstracted topics.

Output: base prompt sentences stored as guidance text.

The server constructs a textual instruction that includes a theme label and requirements for output format, forming a prompt sentence for the generative AI model. The server tokenizes this prompt sentence, provides the tokens to the generative AI model, and obtains generated text sequences. The server post-processes the sequences by trimming, deduplicating, and validating the generated questions or topic descriptions and saves the resulting base prompt sentences in a prompt table.

### Step 4:

The terminal retrieves available themes and base prompt sentences from the server for presentation to the user.

Input: a request from the terminal specifying user profile or session context.

Output: a list of themes and base prompt sentences displayed on the terminal.

The terminal sends a request message to the server, and the server queries the database and returns serialized theme and prompt data. The terminal parses the response and creates interface elements such as list items or buttons, each labeled with a theme and one or more base prompt sentences. The terminal renders these elements on the display for user selection.

### Step 5:

The user selects a theme and a base prompt sentence to start or join a discussion session.

Input: graphical elements displayed on the terminal representing themes and base prompt sentences.

Output: a selection command sent to the server indicating chosen theme and prompt.

The user operates input controls such as touch, mouse, or keyboard to highlight and confirm a chosen theme and base prompt sentence. The terminal packages the selected identifiers into a message and transmits it to the server. The server creates or updates a session record that stores the current theme, the base prompt sentence, and participant identifiers.

### Step 6:

The terminal captures user audio information for utterances in the discussion.

Input: acoustic signals from the user's speech received by the microphone.

Output: digital audio segments suitable for speech recognition.

The terminal samples the analog microphone signal at a defined sampling rate, applies an analog-to-digital conversion, and buffers the resulting PCM data. The terminal segments the audio into fixed or variable length chunks and encodes them in a prescribed format. The terminal attaches session and user identifiers and transmits the encoded audio chunks to a speech recognition component.

### Step 7:

The terminal converts user audio information into character information by performing or invoking speech recognition processing.

Input: encoded digital audio segments containing user speech.

Output: character information representing recognized text of each utterance.

The terminal calls a speech recognition engine, sending audio segments and language settings. The engine applies acoustic and language models to compute the most probable word sequences and returns text strings and timing information. The terminal assembles partial hypotheses into complete utterances, assigns timestamps, and displays the recognized text locally. The terminal transmits the character information, along with timing and identification data, to the server.

### Step 8:

The server analyzes the received character information using a natural language processing technique.

Input: character information representing user utterances with timestamps and identifiers.

Output: syntactic information, semantic information, and intermediate features for evaluation.

The server tokenizes the text into words, tags each token with a part of speech, and builds a dependency tree for each sentence. The server derives syntactic information such as head-dependent relations and phrase boundaries, and semantic information such as detected entities, sentiment clues, and discourse markers. The server stores these derived features in association with the corresponding utterance records.

### Step 9:

The server generates evaluation information for language expressions used in the discussion.

Input: syntactic information, semantic information, and utterance text.

Output: evaluation information indicating grammatical accuracy, lexical appropriateness, logical consistency, and fluency.

The server applies rule-based checks to the dependency tree to detect pattern violations such as missing auxiliary verbs or incorrect word order. The server computes vocabulary statistics by comparing the tokens against frequency lists and proficiency-level lexicons. The server identifies cohesive devices and analyzes sentence linking to assess logical consistency. The server calculates fluency indicators from utterance length and pause patterns. The server aggregates these calculations into numerical scores and annotations and stores them as evaluation information.

### Step 10:

The server performs emotion analysis processing on the character information.

Input: utterance text and derived features such as sentence embeddings.

Output: emotion information indicating emotion types and emotion intensities.

The server converts each utterance into a vector representation using an embedding model and feeds the vector into an emotion classifier network. The classifier outputs probabilities for predefined emotion categories. The server multiplies or maps these probabilities to intensities and assigns an emotion type and intensity to each utterance. The server associates this emotion information with the evaluation information for that utterance.

### Step 11:

The server constructs a feedback-oriented prompt sentence for the generative AI model.

Input: utterance text, evaluation information, and emotion information for a particular user utterance.

Output: a feedback-oriented prompt sentence specifying instructions and context.

The server formats the original utterance, lists detected issues and scores, and states emotion information in natural language within a structured instruction. The server includes task directives such as requesting overall comments and example corrections. The server concatenates these components into a single prompt sentence string and prepares it as input for the generative AI model.

### Step 12:

The server generates feedback text for the user by using the generative AI model and the constructed feedback-oriented prompt sentence.

Input: the feedback-oriented prompt sentence describing the utterance and desired feedback.

Output: feedback text customized to the user's utterance.

The server encodes the prompt sentence into tokens and passes the tokens into the generative AI model, which performs layer-wise computations to produce token probabilities for output text. The server decodes the model output using a defined decoding strategy to obtain coherent sentences. The server optionally filters or truncates the generated text and stores the feedback text associated with the utterance and user.

### Step 13:

The terminal acquires and displays the feedback text for the corresponding utterance.

Input: a request from the terminal identifying an utterance and a response from the server containing feedback text.

Output: on-screen feedback information and optionally audio feedback.

The terminal sends a query to the server for feedback related to a specific utterance identifier.

The server returns the stored feedback text, and the terminal renders the feedback text near the recognized utterance in the user interface. The terminal may call a text-to-speech module to convert the feedback text or corrected sentences to audio and play them through the speaker for the user.

### Step 14:

The server aggregates evaluation information and emotion information across multiple utterances to generate performance information for each user.

Input: a set of utterance-level evaluation information and emotion information for a user.

Output: performance information summarizing language ability and emotional expression trends.

The server retrieves all relevant utterance records for a user within a session or across sessions. The server computes aggregate statistics such as average scores, variance, and trend indicators over time. The server identifies repeated error types and typical emotion patterns.

The server stores these aggregates as performance information linked to the user profile.

### Step 15:

The server generates adaptive practice prompt sentences based on performance information by using the generative AI model.

Input: performance information describing a user's weaknesses and strengths.

Output: adaptive practice prompt sentences tailored to that user.

The server constructs a meta-level prompt sentence that summarizes key characteristics from the performance information and specifies a task for generating practice prompts. The server feeds this prompt sentence into the generative AI model and obtains a set of new prompt sentences focused on problematic areas, such as specific grammatical topics or discourse skills. The server stores and tags these adaptive prompt sentences for later use.

### Step 16:

The terminal presents adaptive practice prompt sentences to the user for targeted practice.

Input: adaptive prompt sentences retrieved from the server for a particular user.

Output: displayed practice tasks that the user can select and respond to.

The terminal requests available adaptive prompts for the user, receives the text of the prompt sentences, and formats them as selectable practice items. The user reads the prompts and may choose one to start a focused practice sequence. The terminal then reuses the audio capture and recognition pipeline to collect responses, and the server processes those responses in the same way as discussion utterances.

### Step 17:

The server monitors utterance intervals and lengths to detect silent states and hesitating states during a discussion.

Input: timestamps and durations of utterances for all participants in a session.

Output: indicators of silent or hesitating states for the session and specific participants.

The server maintains a running log of utterance times and computes the elapsed time since the last utterance. The server compares the elapsed time to predefined thresholds to determine whether a silent state exists. The server also analyzes transcripts for filler tokens and aborted phrases, correlating them with short or fragmented utterances to detect hesitating states. The server records these states as status flags for the session.

### Step 18:

The server constructs a flow-control prompt sentence for the generative AI model to generate dialogue-support utterances.

Input: recent utterance text, silent or hesitating state flags, and emotion information.

Output: a flow-control prompt sentence specifying context, goal, and desired output type.

The server selects a window of recent utterances and summarizes them, including participant identifiers and emotion labels. The server states the detected state, such as a particular participant being silent, and defines a goal, such as encouraging participation or calming tension. The server formulates these elements into a prompt sentence that instructs the generative AI model to output a question sentence or topic-presentation sentence with specified tone and complexity.

### Step 19:

The server generates dialogue-support utterances with the generative AI model based on the flow-control prompt sentence.

Input: the flow-control prompt sentence describing context and required utterance characteristics.

Output: one or more dialogue-support utterances such as question sentences or topic-presentation sentences.

The server feeds the flow-control prompt sentence into the generative AI model and obtains generated text that aligns with the requested function, such as asking a targeted question or proposing a new subtopic. The server may rank or filter multiple candidate outputs and select one as the final support utterance. The server links this text to the current session as a suggested moderator or assistant message.

### Step 20:

The terminal receives and outputs dialogue-support utterances to assist discussion control.

Input: dialogue-support utterances sent from the server for the current session.

Output: visual or audio presentation of assistant suggestions to the user or moderator.

The terminal receives the support utterance text and displays it in a distinct area of the interface, labeling it as a suggestion or assistant message. The user or moderator can read and speak the suggestion, or the terminal can convert the support utterance to audio and play it directly. This output prompts further user responses, which re-enter the processing flow through audio capture and recognition in the earlier steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

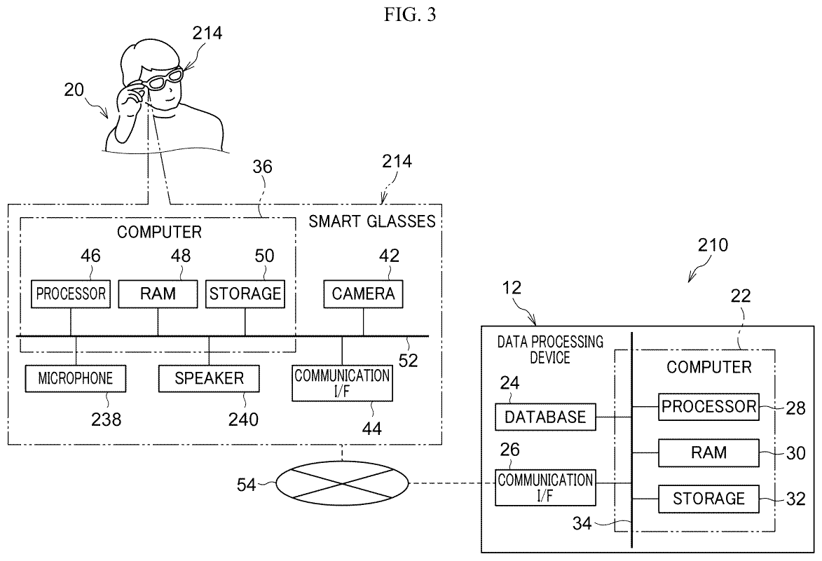

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

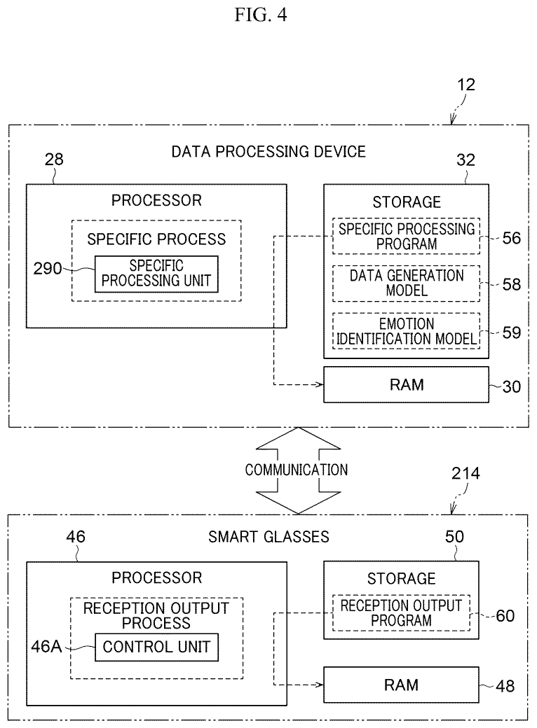

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

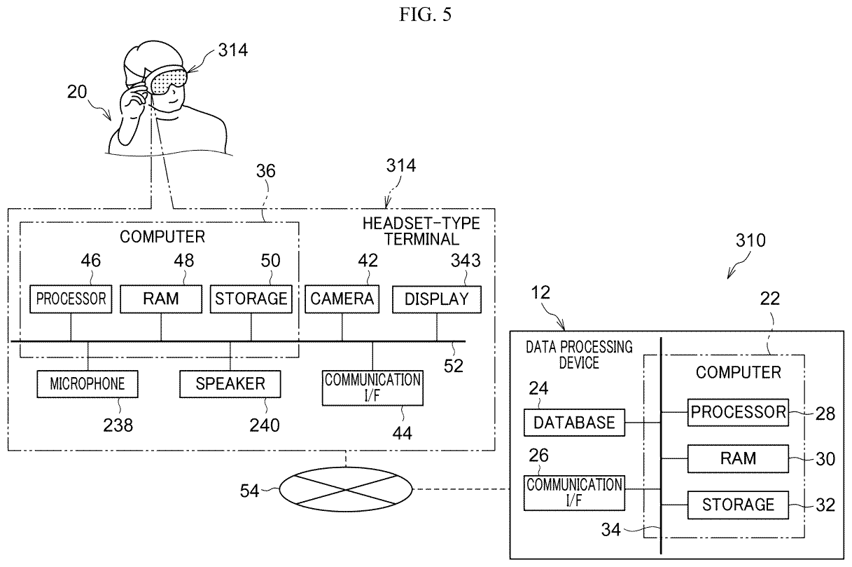

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

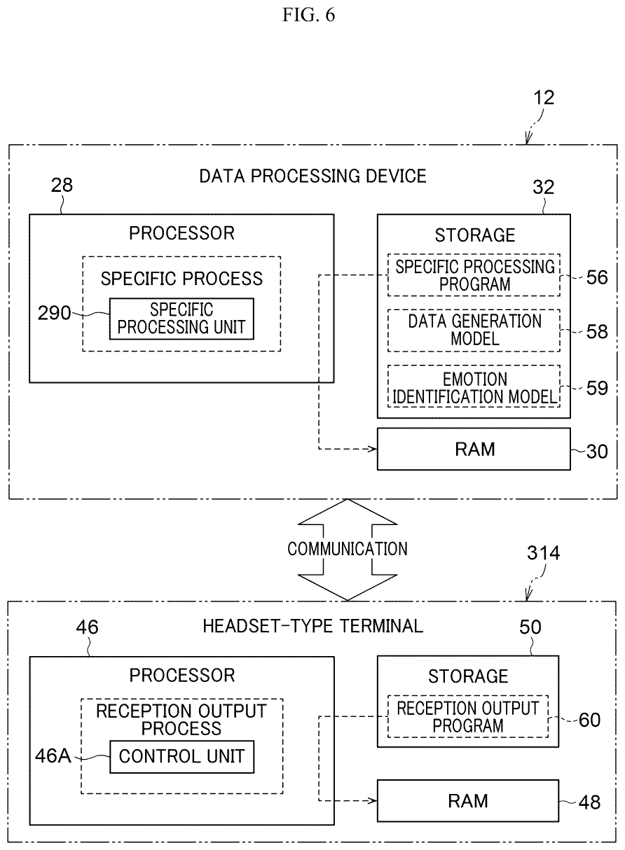

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

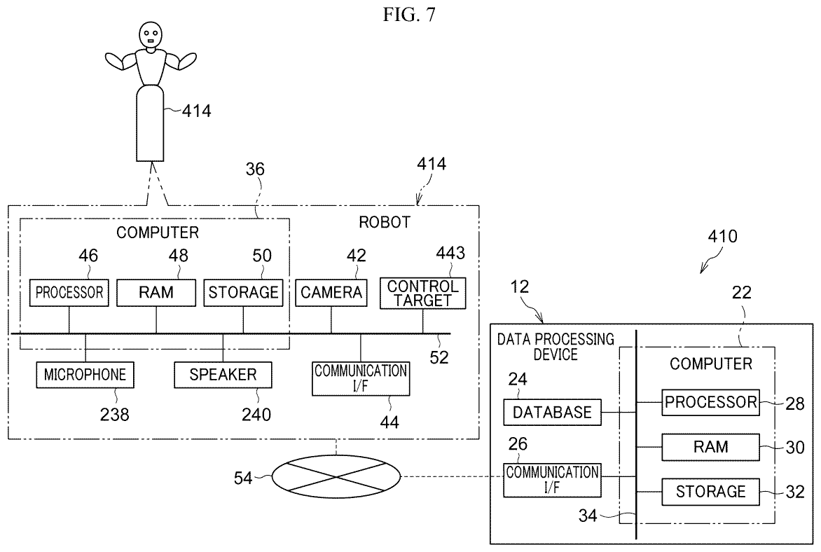

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

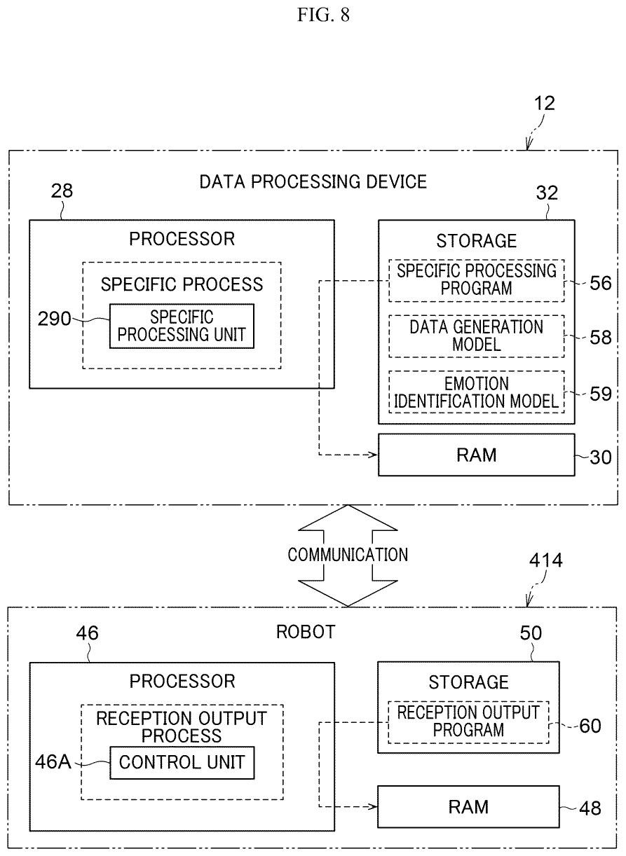

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

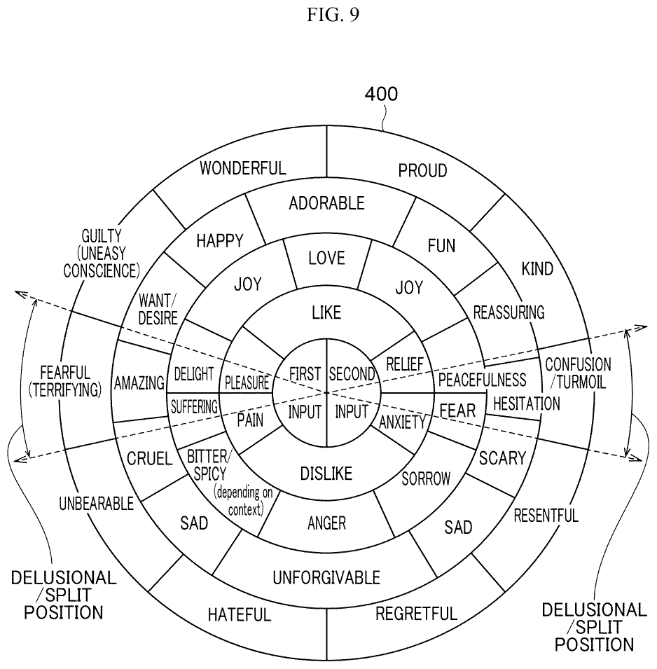

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

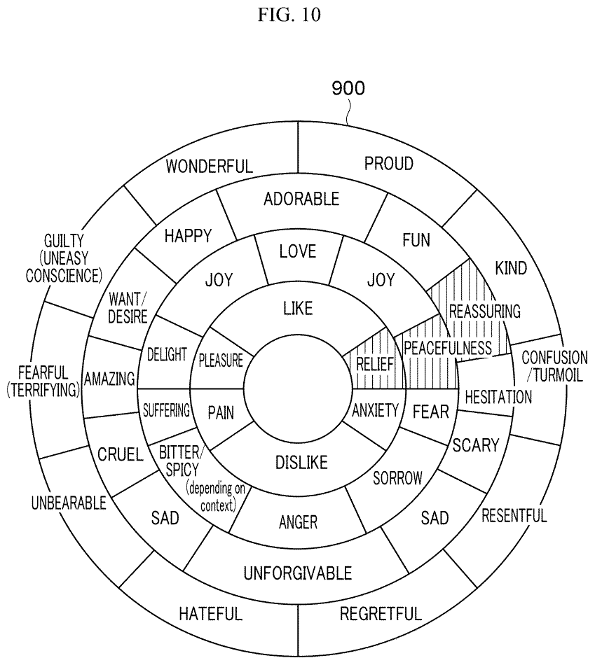

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
analyze text information acquired from an information source and generate summary information and debate-theme information, and
use a generative AI model to generate a prompt sentence for starting a debate by a user and a prompt sentence for managing a progression of the debate, based on the debate-theme information, and
acquire audio information uttered by the user and convert the audio information into character information by speech recognition processing, and
use the generative AI model to analyze the character information and the debate-theme information by natural language processing, and evaluate a language quality, textual correctness, and logical consistency of a content of the user's utterance, and
generate feedback information including favorable points and improvement points of the content of the user's utterance based on the evaluation, and present the feedback information to the user via a terminal device, and
adjust the prompt sentence for a next debate based on the feedback information and a speech history of the user.

### (Supplementary 2)

The system according to supplementary 1,
wherein the processor is configured to
cause the terminal device to provide a user interface that outputs the feedback information as visual display information and audio output information, and receives an input operation for a re-utterance by the user.

### (Supplementary 3)

The system according to supplementary 1,
wherein the processor is configured to
use the generative AI model to generate a customized prompt sentence in which a length, a difficulty, and a depth of discussion points of an utterance content related to the debate-theme information are adjusted according to proficiency information of the user and evaluation result information.

### Application Example 1

### (Supplementary 1)

A system comprising a processor,
wherein the processor is configured to
acquire information distributed from an information providing medium and store the information as character data in a storage device,
analyze the stored character data and extract abstract topic data and related term data, generate, by using a generative AI model, prompt sentences including a plurality of debate instruction sentences on the basis of the extracted topic data and related term data,
convert voice data of a user, which is transmitted from a user terminal, into character data by using a speech recognition device, and analyze the character data as syntactic data, lexical data, and discourse-structure data by using a natural language processing device,
calculate evaluation data indicating quality data of language data used in a debate, correctness data of sentence construction, and validity data of logical construction on the basis of the analyzed syntactic data, lexical data, and discourse-structure data,
generate learning-support feedback data including misuse-expression data, improvement-candidate-expression data, and favorable-expression data on the basis of the calculated evaluation data,
store the generated learning-support feedback data in association with session data and user identification data, and dynamically adjust content, difficulty level, and topic selection of the prompt sentences in a subsequent debate session on the basis of a storage result, and
manage utterance data acquired from a plurality of user terminals together with time-series data and speaker-identification data, and function as a debate moderator by generating, by using the generative AI model, follow-up prompt sentences according to debate progress and distributing the follow-up prompt sentences to the plurality of user terminals.

### (Supplementary 2)

The system according to supplementary 1,
wherein the processor is configured to
calculate, for a plurality of utterances of the user, vocabulary-diversity data, sentence-length statistical data, and logical-connector usage-frequency data by using the natural language processing device, store the calculated data in a time series, and generate, by using the generative AI model, feedback sentences including ability-estimation data and long-term learning-trend data for each user.

### (Supplementary 3)

The system according to supplementary 1,
wherein the processor is configured to
receive, at a time of generating the debate instruction sentences, evaluation data, user-attribute data, and history data of past sessions as input conditions, and generate, by using the generative AI model, customized prompt sentences in which topic, expression difficulty level, and utterance format are controlled for each user.

### Example 2

### (Supplementary 1)

A system comprising a processor,
wherein the processor is configured to
analyze information acquired from an external information source and extract important concepts or topics, and
generate, by using a generative AI model, a prompt sentence based on the extracted concepts or topics and create instruction information including the prompt sentence, and receive, via a communication device, voice data or text data acquired from a user terminal,
convert the voice data into text data, analyze the text data by using natural language processing, and evaluate a discussion progress state by calculating, for utterances in a discussion, time information of the utterances, a number of utterances, and a speaking ratio for each speaker, and
input, when the discussion progress state satisfies a predetermined condition, a prompt sentence including a discussion topic, recent utterance content, and an evaluation result of the discussion progress state into the generative AI model, and obtain a generated question sentence or a generated activation message for promoting utterances, and
transmit the obtained question sentence or activation message to the user terminal and cause the user terminal to display the question sentence or activation message on a discussion screen so as to promote user utterances, and
analyze text data used in the discussion by using the natural language processing and the generative AI model, evaluate grammatical correctness, semantic clarity, and logical consistency, and generate feedback information for each user including improvement points and examples of favorable expressions, and
transmit the feedback information to the user terminal and reflect the feedback information in generation conditions of the prompt sentence and the question sentence in subsequent discussions.

### (Supplementary 2)

The system according to supplementary 1,
wherein the processor is configured to repeatedly evaluate the discussion progress state at predetermined time intervals during the discussion and, in accordance with a result of the evaluation, dynamically change content of the prompt sentence to be input to the generative AI model, a number of question sentences to be generated, and a difficulty level of the question sentences.

### (Supplementary 3)

The system according to supplementary 1,
wherein the processor is configured to generate, by using an utterance history for each user and the feedback information, a customized prompt sentence for each user including instructions regarding utterance content, expression style, and logical structure for a specific topic, and input the customized prompt sentence into the generative AI model so as to cause the generative AI model to generate, for each user, a question sentence or an utterance instruction sentence different from those for other users.

### Application Example 2

### (Supplementary 1)

A system comprising a processor,
wherein the processor is configured to
analyze document information acquired from an external information source and extract theme information and phrase information represented as higher-level concepts from the document information,
generate, by using a generative AI model, a prompt sentence serving as a discussion subject on the basis of the extracted theme information and phrase information, and store the prompt sentence as guidance text for a discussion,
convert user audio information input from an audio acquisition device into character information by performing speech recognition processing, and analyze the character information as syntactic information and semantic information by using a natural language processing technique,
generate evaluation information for language expressions used in the discussion, the evaluation information indicating grammatical accuracy, lexical appropriateness, logical consistency, and fluency of utterances, on the basis of an analysis result of the character information,
perform emotion analysis processing on the character information, identify emotion information indicating emotion types and emotion intensities, and associate the emotion information with the evaluation information,
construct a prompt sentence for the generative AI model on the basis of input information including the analysis result containing the evaluation information and the emotion information, and automatically generate feedback text for each user by using the prompt sentence with the generative AI model,
aggregate the evaluation information and the emotion information in time series and generate performance information indicating characteristics of language ability and emotional expression for each user,
generate, on the basis of the performance information, a new prompt sentence adapted to weaknesses and strengths of each user for subsequent discussions, and generate the new prompt sentence as utterance text for dialogue control that controls progress of the discussion, monitor intervals and lengths of utterances during progress of the discussion, detect a silent state or a hesitating state, and, on the basis of a detection result and the emotion information,
generate, by using the generative AI model, a question sentence or a topic-presentation sentence that activates the discussion, and
transmit the generated feedback text, the question sentence, and the topic-presentation sentence to a terminal device and cause the terminal device to perform display output or audio output of the feedback text, the question sentence, and the topic-presentation sentence.

### (Supplementary 2)

The system according to supplementary 1,
wherein the processor is configured to store the generated feedback text and the performance information in a storage region, and to reflect a storage result in the prompt sentence for the generative AI model so as to sequentially update content and difficulty of the prompt sentence in accordance with a proficiency level and an interest of each user.

### (Supplementary 3)

The system according to supplementary 1,
wherein the processor is configured to recognize an emotional state including at least one of anger, joy, and sadness during the progress of the discussion on the basis of an emotion analysis result, and, when the emotional state satisfies a predetermined condition, generate, by using a prompt sentence for the generative AI model, adjustment utterance text that calms or activates the emotional state, and provide the adjustment utterance text to the terminal device as intervention utterance text of a moderator of the discussion.

What is claimed is:

1. A system comprising:
circuitry configured to:
acquire, via a communication interface coupled to a packet-switched network, text information from an information source and generate, using a generative neural network model, summary information and theme information from the text information;
generate, using the generative neural network model and based on the theme information, a first prompt sequence for initiating an interactive session and one or more subsequent prompt sequences for managing progression of the interactive session;
receive, via the communication interface, audio information from a terminal device and convert the audio information into character information by applying speech recognition processing to the audio information;
analyze the character information together with the theme information using natural language processing to evaluate a language quality metric, a textual correctness metric, and a logical consistency metric of the character information;
generate feedback information comprising favorable aspect data and improvement aspect data based on the evaluation and transmit the feedback information to the terminal device via the communication interface; and
store the character information and the evaluation as session history records and adjust at least one subsequent prompt sequence based on the session history records.

2. The system of claim 1, wherein the circuitry is configured to construct a prompt sentence embedding the text information as a content section and an instruction section and input the prompt sentence to the generative neural network model to produce the summary information and the theme information as separate output segments.

3. The system of claim 2, wherein the circuitry is configured to extract a first output segment corresponding to the summary information and a second output segment corresponding to the theme information from model output and store the summary information and the theme information in association with a record identifier in a storage device.

4. The system of claim 3, wherein the text information comprises article content acquired from a network-accessible content delivery service, and the circuitry is configured to parse a hypertext response, remove non-content markup elements, normalize character encoding, and store cleaned article text in the storage device.

5. The system of claim 4, wherein the circuitry is configured to retrieve the theme information from the storage device, construct a theme-conditioned prompt sentence instructing the generative neural network model to produce an open-ended question, and store the resulting first prompt sequence in association with the theme information.

6. The system of claim 1, wherein the circuitry is configured to maintain a conversation context data structure storing a sequence of prior character information entries and system prompt sequences with associated timestamps and role annotations, and construct a composite input comprising the theme information, the conversation context data structure, and a progression instruction as input to the generative neural network model to generate each subsequent prompt sequence.

7. The system of claim 6, wherein the circuitry is configured to reuse stored context representations across multiple interactive session turns to reduce repeated computation, and transmit each subsequent prompt sequence to the terminal device via the communication interface upon generation.

8. The system of claim 1, wherein the speech recognition processing applies a neural network-based automatic speech recognition model that maps sequences of acoustic feature vectors to sequences of text tokens using beam search decoding to produce the character information.

9. The system of claim 8, wherein the acoustic feature vectors comprise Mel-frequency cepstral coefficients computed per audio frame, and the circuitry is configured to receive the audio information together with a session identifier and a user identifier as associated metadata.

10. The system of claim 1, wherein the circuitry is configured to construct an evaluation prompt sentence encoding the theme information, the character information, and multi-dimensional analysis instructions, input the evaluation prompt sentence to the generative neural network model, and post-process model output by parsing the output into structured components corresponding to the favorable aspect data and the improvement aspect data.

11. The system of claim 10, wherein the circuitry is configured to complement model output with rule-based checks applied by a natural language processing library and cross-validate grammar correction suggestions from the generative neural network model with rule-based findings before generating the feedback information.

12. The system of claim 11, wherein the feedback information is transmitted to the terminal device as visual display information and as audio output information generated by a text-to-speech component.

13. The system of claim 1, wherein the session history records comprise per-session fields including utterance text, grammatical error counts, vocabulary diversity measures, logical coherence scores, and timestamps, stored as records linked to a user profile.

14. The system of claim 13, wherein the circuitry is configured to compute proficiency information comprising a grammar proficiency level, a vocabulary breadth index, and a logical reasoning score from the session history records using statistical methods applied to feature progressions over stored sessions.

15. The system of claim 14, wherein the circuitry is configured to adjust the at least one subsequent prompt sequence by selecting or modifying a prompt template based on the proficiency information, wherein the template includes variable parameters for target length, lexical complexity, and required depth of discussion points.

16. The system of claim 15, wherein the circuitry is configured to instantiate the template into a concrete prompt sentence and supply the concrete prompt sentence to the generative neural network model to produce a refined subsequent prompt sequence having difficulty calibrated to the proficiency information.

17. The system of claim 1, wherein the circuitry is configured to execute a secondary discriminative neural network model to estimate a confidence score for each item in the feedback information and suppress or flag low-confidence items before transmitting the feedback information to the terminal device.

18. A system comprising:
circuitry configured to:
acquire, via a communication interface coupled to a packet-switched network, article text from a network-accessible information source, construct a multi-task prompt sentence embedding the article text as a content section, and input the multi-task prompt sentence to a transformer-based generative neural network model to generate summary information and theme information as separate output segments;
retrieve the theme information and generate, using the transformer-based generative neural network model, a first prompt sequence comprising an open-ended question conditioned on the theme information and one or more subsequent prompt sequences constructed from a conversation context data structure storing prior character information entries and system prompt sequences with role annotations;
receive audio information from a terminal device via the communication interface, extract acoustic feature vectors from the audio information, and convert the audio information into character information by applying a neural network-based speech recognition model using beam search decoding;
construct an evaluation prompt sentence encoding the theme information, the character information, and multi-dimensional analysis instructions and input the evaluation prompt sentence to the transformer-based generative neural network model to evaluate a language quality metric, a textual correctness metric, and a logical consistency metric;
parse model output into favorable aspect data and improvement aspect data, cross-validate with rule-based natural language processing checks, and transmit resulting feedback information to the terminal device; and
store character information and evaluation results as session history records comprising per-session metrics and adjust at least one subsequent prompt sequence by selecting a prompt template parameterized by proficiency information derived from the session history records.

19. The system of claim 18, wherein the circuitry is configured to compute the proficiency information comprising a grammar proficiency level, a vocabulary breadth index, and a logical reasoning score from the session history records and instantiate the prompt template by substituting variable parameters for target length, lexical complexity, and required depth of discussion points based on the proficiency information.

20. A method comprising:
acquiring, via a communication interface coupled to a packet-switched network, text information from an information source and generating, using a generative neural network model, summary information and theme information from the text information;
generating, using the generative neural network model and based on the theme information, a first prompt sequence for initiating an interactive session and one or more subsequent prompt sequences for managing progression of the interactive session;
receiving, via the communication interface, audio information from a terminal device and converting the audio information into character information by applying speech recognition processing to the audio information;
analyzing the character information together with the theme information using natural language processing to evaluate a language quality metric, a textual correctness metric, and a logical consistency metric of the character information;
generating feedback information comprising favorable aspect data and improvement aspect data based on the evaluation and transmitting the feedback information to the terminal device via the communication interface; and
storing the character information and the evaluation as session history records and adjusting at least one subsequent prompt sequence based on the session history records.
